(19) United States
(12) Patent Application Publication
(10) Pub. No.: US 2016/0016581 A1
(43) Pub. Date: Jan. 21, 2016

(54) TRAVEL MOTION CONTROL DEVICE FOR VEHICLE

(71) Applicant: Takahiro YOKOTA, Toyota-shi, Aichi (JP)

(72) Inventor: Takahiro YOKOTA, Susono-shi (JP)

(73) Assignee: TOYOTA JIDOSHA KABUSHIKI KAISHA, Toyota-shi, Aichi (JP)

(21) Appl. No.: 14/772,593

(22) PCT Filed: Mar. 4, 2013
(86) PCT No.: PCT/JP2013/055869

§ 371 Date: Sep. 3, 2015

(51) Int. Cl. B60W 30/02; B62D 6/00; B60T 8/1755

(52) U.S. Cl. CPC B60W 30/02; B60T 8/1755; B62D 6/008; B62D 6/001

(57) ABSTRACT

A reference yaw rate of a vehicle in a relationship of a first-order lag with respect to a normative yaw rate is calculated by using a time constant of a first-order lag set in advance (S320), and when a magnitude of a deviation between an actual yaw rate and the reference yaw rate of the vehicle exceeds a threshold, vehicle motion control by controlling braking/driving force of each wheel is carried out so as to decrease the magnitude of the deviation (S420 to S500). A correction value (Δγcs) is acquired for preventing unnecessary execution of the vehicle motion control caused by the time constant different from an actual value resulting from a change in an overall weight of the vehicle or a change in a vehicle longitudinal direction position of a vehicle center of gravity (S330 to S390), and the threshold is corrected by using the correction value (S420).

### TECHNICAL FIELD

The present invention relates to control of a travel motion of a vehicle such as a motor vehicle, and more particularly, to a travel motion control device for controlling a travel motion of a vehicle based on a deviation between an actual motion state amount of the vehicle and a reference motion state amount of the vehicle.

### BACKGROUND ART

In the control of the travel motion of the vehicle, based on determination of whether or not a magnitude of a deviation between an actual yaw rate as an actual motion state amount of the vehicle and a reference yaw rate as a reference motion state amount of the vehicle exceeds a reference value, determination is made of whether or not a turn behavior of the vehicle is degraded. Then, when it is determined that the turn behavior is degraded, the travel motion of the vehicle is stabilized by controlling a braking force and a steering angle of each of wheels. In this case, the reference yaw rate is calculated as a value in a relationship of a first-order lag with respect to a normative yaw rate of the vehicle acquired based on a vehicle speed, a steering angle of front wheels, and a lateral acceleration of the vehicle.

A time constant of the first-order lag depends on the vehicle speed, and changes based on a load state of the vehicle. In particular, in the case of a vehicle such as a bus or a truck having a large variation of a movable load and a large variation of a center of gravity of the vehicle, a change in time constant of the first-order lag depending on the load state becomes larger compared to a passenger vehicle. Therefore, for example, as disclosed in Patent Literature 1, there has already been proposed a device for estimating a longitudinal position of the center of gravity of a vehicle and axle loads of the front and rear wheels, thereby estimating cornering powers of tires of the front and rear wheels that may cause a variation in the time constant of the first-order lag based on the estimation results.

If this estimation device is installed, the time constant of the first-order lag can be corrected based on the estimated cornering powers of the tires of the front and rear wheels. Thus, even for the vehicle having the larger variations in the movable load and in the center of gravity, the travel motion of the vehicle can appropriately be controlled during a turn compared to a case in which the time constant of the first-order lag is not corrected based on the cornering powers.

### CITATION LIST

### Patent Literature

[PTL 1] WO 2010/082288 A1

### SUMMARY OF INVENTION

### Technical Problem

However, the time constant of the first-order lag may also change depending on a change in yaw moment of inertia of the vehicle, and the yaw moment of inertia of the vehicle may also change depending on the load state of the vehicle. Therefore, it is difficult to estimate the overall weight of the vehicle, the vehicle longitudinal direction position of the vehicle center of gravity, and the like, and to correctly estimate the time constant of the first-order lag based on the estimation results. Moreover, there is such a fear that, as a result of incorrect estimation of the time constant of the first-order lag, a turn behavior of the vehicle is determined to be degraded while the actual turn behavior of the vehicle is not degraded, and stabilization of a travel motion of the vehicle by means of control of braking forces of wheels and a steering angle is started unnecessarily early.

Moreover, a reference yaw rate as the reference motion state amount of the vehicle is also used for other types of the control of the vehicle such as the antiskid control and the traction control. Therefore, when the reference yaw rate is calculated by using an incorrect time constant of the first-order lag estimated based on estimation results of the overall weight of the vehicle, the vehicle longitudinal direction position of the vehicle center of gravity, and the like, there is such a fear that an calculation error and the like affect other types of control of the vehicle.

The present invention has been made in view of the above-mentioned problems in the motion control of the vehicle based on the deviation between the actual motion state amount of the vehicle and the reference motion state amount of the vehicle. Then, a primary object of the present invention is to reduce the fear that the stabilization of the travel motion of the vehicle based on the deviation of the motion state amount is started unnecessarily early while the calculation error in the time constant of the first-order lag and the like are prevented from affecting other types of control of the vehicle.

### Solution to Problem and Advantageous Effects of Invention

In order to achieve the above-mentioned primary object, according to one embodiment of the present invention, there is provided a travel motion control device for a vehicle, which is configured to calculate, by using a time constant of a first-order lag set in advance, a reference motion state amount of the vehicle in a relationship of the first-order lag with respect to a normative motion state amount of the vehicle, to thereby control, when a magnitude of a deviation between an actual motion state amount of the vehicle and the reference motion state amount of the vehicle exceeds a threshold, a braking/driving force of each wheel or a steering angle of a steering wheel so as to decrease the magnitude of the deviation, the travel motion control device being configured to: acquire a correction value corresponding to a calculation error in the reference motion state amount of the vehicle caused by a difference of the time constant of the first-order lag from an actual value resulting from at least one of a change in an overall weight of the vehicle or a change in a vehicle longitudinal direction position of a vehicle center of gravity; and correct one of the magnitude of the deviation and the threshold by using the correction value.

In the above-mentioned configuration, the correction value corresponding to the calculation error in the reference motion state amount of the vehicle caused by the difference of the time constant of the first-order lag from the actual value resulting from at least one of the change in the overall weight of the vehicle or the change in the vehicle longitudinal direction position of the vehicle center of gravity is acquired. Then, one of the threshold and the magnitude of the deviation between the actual motion state amount and the reference motion state amount is corrected by using the correction value.

Thus, even when the overall weight of the vehicle and the vehicle longitudinal direction position of the vehicle center of gravity change, the influence of the calculation error caused by the difference of the time constant of the first-order lag from the actual value can be eliminated, and whether or not the magnitude of the deviation of the motion state amount exceeds the threshold can be determined. Thus, even when the overall weight of the vehicle and the vehicle longitudinal direction position of the vehicle center of gravity change, the fear that the stabilization of the travel motion of the vehicle is started unnecessarily early resulting from the changes can be reduced. Moreover, one of the magnitude of the deviation and the threshold is corrected by using the correction value corresponding to the calculation error, and hence such a fear that the start of the stabilization of the travel motion of the vehicle is delayed can appropriately be reduced compared with such a case that one of the magnitude of the deviation and the threshold is corrected by using a correction value not corresponding to the calculation error.

Moreover, the reference motion state amount of the vehicle is calculated by using not the time constant of the first-order lag estimated based on the estimation results of the overall weight of the vehicle, the vehicle longitudinal direction position of the vehicle center of gravity, and the like, but the time constant of the first-order lag set in advance. Thus, for example, the calculation error in the reference motion state amount resulting from the estimation error in the time constant of the first-order lag is effectively prevented from affecting other types of control of the vehicle.

Further, according to one embodiment of the present invention, in the above-mentioned configuration, the correction value may be a minimum value of a correction amount required for correcting one of the threshold and the magnitude of the deviation between the actual motion state amount of the vehicle and the reference motion state amount of the vehicle in order to prevent such a determination that the magnitude of the deviation exceeds a standard threshold set in advance for a standard state of the vehicle. The travel motion control device may include a storage device for storing a relationship acquired in advance between the correction value and each of the overall weight of the vehicle and a stability factor of the vehicle. The travel motion control device may estimate the overall weight of the vehicle and the stability factor of the vehicle, and calculate the correction value by the storage device based on the estimated overall weight of the vehicle and stability factor of the vehicle.

In the above-mentioned configuration, the overall weight of the vehicle and the stability factor of the vehicle are estimated, and the correction value is calculated by the storage device based on the estimated overall weight of the vehicle and stability factor of the vehicle. Thus, even when the overall weight of the vehicle and the vehicle longitudinal direction position of the vehicle center of gravity change, the correction value can easily and efficiently be calculated in accordance with those changes. Thus, compared with the case in which the calculation error is acquired based on the estimation results of the overall weight of the vehicle, the vehicle longitudinal direction position of the vehicle center of gravity, and the like, and the correction value is calculated based on the calculation error, the calculation load on the travel motion control device can be reduced.

Moreover, the correction value is the minimum value of the correction amount for preventing the magnitude of the deviation of the yaw rate from being determined to exceed the standard threshold. Thus, the magnitude of the deviation or the threshold can be prevented from being excessively corrected, and, as a result, the delay of the start of the stabilization of the travel motion of the vehicle resulting from the excessive correction can be avoided.

Further, according to one embodiment of the present invention, in the above-mentioned configuration, the actual motion state amount of the vehicle and the reference motion state amount of the vehicle may respectively be an actual yaw rate of the vehicle and a reference yaw rate of the vehicle. The actual yaw rate of the vehicle and a lateral acceleration of the vehicle may be calculated based on a vehicle speed and a steering angle of a front wheel by using a two-wheel model of the vehicle in which the overall weight of the vehicle and the stability factor of the vehicle are variable parameters. The reference yaw rate of the vehicle may be calculated based on the vehicle speed, the steering angle of the front wheel, and the calculated lateral acceleration of the vehicle by using the stability factor of the vehicle and the time constant of the first-order lag set in advance for the standard state of the vehicle. The correction value may be a value acquired for various overall weights and stability factors of the vehicle as the minimum value of the correction amount in order to prevent such a determination that a magnitude of a deviation between the calculated yaw rate of the vehicle and the calculated reference yaw rate of the vehicle exceeds the standard threshold.

In the above-mentioned configuration, the two-wheel model of the vehicle in which the overall weight of the vehicle and the stability factor of the vehicle are the variable parameters is used to calculate the yaw rate of the vehicle and the lateral acceleration of the vehicle based on the vehicle speed and the steering angle of the front wheel. Then, the stability factor of the vehicle and the time constant of the first-order lag set in advance for the standard state of the vehicle are used to calculate the reference yaw rate of the vehicle based on the vehicle speed, the steering angle of the front wheel, and the calculated lateral acceleration of the vehicle. Thus, compared with the case in which the yaw rate of the vehicle and the lateral acceleration of the vehicle are detected, the number of required detection devices can be reduced, and the calculation error in the reference yaw rate resulting from an accumulation of a gain error of the detection device and the like can be reduced.

Further, according to one embodiment of the present invention, in the above-mentioned configuration, the correction value may be a value for preventing, when the vehicle speed, a magnitude of the steering angle of the front wheel, a magnitude of the lateral acceleration of the vehicle, and a steering frequency are respectively less than corresponding reference values, the determination that the magnitude of the deviation between the calculated yaw rate of the vehicle and the calculated reference yaw rate of the vehicle exceeds the standard threshold.

In the above-mentioned configuration, the correction value is a correction value for the case in which the vehicle speed, the magnitude of the steering angle of the front wheel, the magnitude of the lateral acceleration of the vehicle, and the steering frequency are respectively less than the corresponding reference values. Thus, in the case in which the vehicle speed and the like are respectively less than the corresponding reference values, even when the overall weight of the vehicle and the vehicle longitudinal direction position of the vehicle center of gravity change, the fear that the stabilization of the travel motion of the vehicle is started unnecessarily early resulting from those changes can be reliably reduced.

Further, according to one embodiment of the present invention, in the above-mentioned configuration, the two-wheel model may be a two-wheel model in which the vehicle longitudinal direction position of the vehicle center of gravity, cornering powers of the front wheel and a rear wheel, and a yaw moment of inertia of the vehicle are variably set depending on the overall weight of the vehicle and the stability factor of the vehicle, and the time constant of the first-order lag is variably set depending on the yaw moment of inertia and the cornering powers of the front wheel and the rear wheel.

In the above-mentioned configuration, the vehicle longitudinal direction position of the vehicle center of gravity, the cornering powers of the front wheel and the rear wheel, and the yaw moment of inertia of the vehicle of the two-wheel model are variably set depending on the overall weight of the vehicle and the stability factor of the vehicle. Moreover, the time constant of the first-order delay of the two-wheel model is variably set depending on the yaw moment of inertia and the cornering powers of the front wheel and the rear wheel. Thus, even when the overall weight of the vehicle and the vehicle longitudinal direction position of the vehicle center of gravity change, the yaw rate of the vehicle and the lateral acceleration of the vehicle reflecting those changes can be correctly calculated, and thus the reference yaw rate of the vehicle can be correctly calculated.

Further, according to one embodiment of the present invention, in the above-mentioned configuration, the yaw moment of inertia of the vehicle may be variably set by estimating a change amount of the overall weight of the vehicle and a change amount of the vehicle longitudinal direction position of the vehicle center of gravity with respect to the standard state of the vehicle based on the overall weight of the vehicle and the stability factor of the vehicle, estimating a change amount of the yaw moment of inertia of the vehicle based on the change amount of the overall weight of the vehicle and the change amount of the vehicle longitudinal direction position of the vehicle center of gravity, and calculating the yaw moment of inertia as a sum of the estimated change amount of the yaw moment of inertia and the yaw moment of inertia in the standard state of the vehicle.

In the above-mentioned configuration, the change amount of the overall weight of the vehicle and the change amount of the vehicle longitudinal direction position of the vehicle center of gravity with respect to the standard state of the vehicle are estimated, and the change amount of the yaw moment of inertia of the vehicle is estimated based on those change amounts. Then, the sum of the estimated change amount of the yaw moment of inertia and the yaw moment of inertia in the standard state of the vehicle is calculated as the estimated value of the yaw moment of inertia of the vehicle.

Thus, even when the overall weight of the vehicle and the vehicle longitudinal direction position of the vehicle center of gravity change as a result of a change in the load state of the vehicle, the change amount of the yaw moment of inertia of the vehicle resulting from those changes is estimated, and, as a result, the yaw moment of inertia of the vehicle can be correctly estimated. Thus, even when the yaw moment of inertia of the vehicle changes as the load state of the vehicle changes, the correction amount can be calculated so as to reflect the change.

Further, according to one embodiment of the present invention, in the above-mentioned configuration, the standard state of the vehicle may be a standard load state of the vehicle set in advance.

In the above-mentioned configuration, the correction amount is the minimum value of the correction amount required for preventing the magnitude of the deviation of the motion state amount from being determined to exceed the standard threshold set in advance for the standard load state of the vehicle. Thus, even when the overall weight of the vehicle and the vehicle longitudinal direction position of the vehicle center of gravity change from those in the standard load state, the correction amount can be calculated as the minimum value for reducing the fear that the stabilization of the travel motion of the vehicle is started unnecessarily early resulting from those changes.

A wheelbase of a vehicle is represented by L, an actual steering angle of front wheels is represented by δ, and a lateral acceleration of the vehicle is represented by Gy. Moreover, a vehicle speed is represented by V, a stability factor of the vehicle is represented by Kh, and the Laplacian is represented by s. A reference yaw rate of the vehicle γst is represented by Expression (1). In other words, the reference yaw rate of the vehicle γst is calculated as a value of a first-order lag with respect to a normative yaw rate γt, which is a value in parentheses on the right side of Expression (1).

$$γ st = \frac{1}{1 + TpVs} ( \frac{δ V}{L} - KhGyV ) \qquad ( 1 )$$

Tp in Expression (1) is a coefficient multiplied to the vehicle speed V of the time constant of the first-order lag, and a product of the vehicle speed V and the coefficient Tp is the time constant of the first-order lag. If the yaw moment of inertia of the vehicle is represented by Iz, and the cornering powers of the front wheel and the rear wheel are respectively represented by Kf and Kr, the coefficient Tp is represented by Expression (2). As used herein, the coefficient is referred to as “steering response time constant coefficient”.

$$Tp = \frac{Iz}{{L}^{2}} ( \frac{1}{Kf} + \frac{1}{Kr} ) \qquad ( 2 )$$

Therefore, in one preferred aspect of the present invention, the reference yaw rate γst of the vehicle as the reference motion state amount of the vehicle may be calculated by using Expression (1).

In another preferred aspect of the present invention, a second correction value for correcting one of the magnitude of the deviation and the threshold may be calculated based on the change amount of the stability factor of the vehicle with respect to the stability factor of the vehicle in the standard state of the vehicle, and, when the second correction value is larger than the correction value based on the calculation error, one of the magnitude of the deviation and the threshold may be corrected to the second correction value.

In another preferred aspect of the present invention, the change amount of the yaw moment of inertia of the vehicle may be estimated as the yaw moment of inertia of only the movable load.

In another preferred aspect of the present invention, when one of the overall weight of the vehicle and the stability factor of the vehicle is equal to or less than a threshold determined by the other thereof, the correction amount may be set to 0.

In another preferred aspect of the present invention, each time the time constant of the first-order lag is updated, the overall weight of the vehicle, the stability factor of the vehicle, and the time constant of the first-order lag are stored in the non-volatile storage device. The difference between the estimated overall weight of the vehicle and the overall weight of the vehicle stored in the storage device and the difference between the estimated stability factor of the vehicle and the stability factor of the vehicle stored in the storage device are respectively set to the change amount of the overall weight of the vehicle and the change amount of the stability factor of the vehicle. When one of the change amount of the overall weight of the vehicle and the change amount of the stability factor of the vehicle is equal to or less than the threshold determined by the other change amount thereof, the correction amount may be set to the value stored in the storage device.

### BRIEF DESCRIPTION OF DRAWINGS

FIG. 1 is a schematic configuration diagram for illustrating a travel motion control device according to a first embodiment of the present invention configured to stabilize a travel motion of a vehicle by controlling braking forces of wheels.

FIG. 2 is a side view for illustrating specifications such as a wheelbase of the vehicle.

FIG. 3 is a flowchart for illustrating a routine of calculating a correction amount Δγcs for a threshold for the travel motion control according to the first embodiment.

FIG. 4 is a flowchart for illustrating a subroutine carried out in Step 300 of the flowchart of FIG. 3.

FIG. 5 is a flowchart for illustrating a routine of controlling travel motion of the vehicle carried out by using the correction amount Δγcs for the threshold.

FIG. 6 is a map for determining whether or not calculation of a steering response time constant coefficient Tp is unnecessary based on an overall weight W of the vehicle and a stability factor Kh of the vehicle.

FIG. 7 is another map for determining whether or not the calculation of the steering response time constant coefficient Tp is unnecessary based on the overall weight W of the vehicle and the stability factor Kh of the vehicle.

FIG. 8 is a flowchart for illustrating a routine of calculating a correction amount Δγcs for a threshold according to a second embodiment of the present invention.

FIG. 9 is a flowchart for illustrating a principal part of the routine of calculating the correction amount for the threshold according to a first modified example corresponding to the first embodiment.

FIG. 10 is a flowchart for illustrating a principal part of the routine of calculating the correction amount for the threshold according to a second modified example corresponding to the second embodiment.

FIG. 11 is a map for calculating the correction amount Δγcs for the threshold when the vehicle is in a spin state based on an overall weight W of the vehicle and a stability factor Kh of the vehicle.

FIG. 12 is a map for calculating the correction amount Δγcs for the threshold when the vehicle is in a drift out state based on the overall weight W of the vehicle and the stability factor Kh of the vehicle.

FIG. 13 is a graph for showing a relationship between an increase amount of the threshold required for preventing determination of the spin state from being made, and the overall weight W and the stability factor Kh.

FIG. 14 is a graph for showing a relationship between an increase amount of the threshold required for preventing determination of the drift out state from being made, and the overall weight W and the stability factor Kh.

FIG. 15 is a map for calculating a cornering power Kf of a tire of a front wheel based on the overall weight W of the vehicle and the stability factor Kh of the vehicle.

FIG. 16 is a map for calculating a cornering power Kr of a tire of a rear wheel based on the overall weight W of the vehicle and the stability factor Kh of the vehicle.

FIG. 17 is a map for calculating a yaw moment of inertia Iz of the vehicle based on the overall weight W of the vehicle and the stability factor Kh of the vehicle.

FIG. 18 is a map for determining whether or not the calculation of the correction amount Δγcs for the threshold is unnecessary based on a change amount ΔW of the overall weight of the vehicle and a change amount ΔKh of the stability factor of the vehicle.

FIG. 19 is another map for determining whether or not the calculation of the correction amount Δγcs for the threshold is unnecessary based on the change amount ΔW of the overall weight of the vehicle and the change amount ΔKh of the stability factor of the vehicle.

FIG. 20 is a map for calculating a movable load Wlo of the vehicle, which is a change amount of the weight of the vehicle with respect to a standard weight Wv, based on the overall weight W of the vehicle and the stability factor Kh of the vehicle.

FIG. 21 is a map for calculating a distance Lf in a vehicle longitudinal direction between a center of gravity of the vehicle and an axle of the front wheel based on the overall weight W of the vehicle and the stability factor Kh of the vehicle.

FIG. 22 is a map for calculating an axle load Wf of the front wheel based on the overall weight W of the vehicle and the stability factor Kh of the vehicle.

FIG. 23 is a map for calculating an axle load Wr of the rear wheel based on the overall weight W of the vehicle and the stability factor Kh of the vehicle.

### DESCRIPTION OF EMBODIMENTS

A detailed description is now given of some preferred embodiments of the present invention referring to accompanying drawings.

### First Embodiment

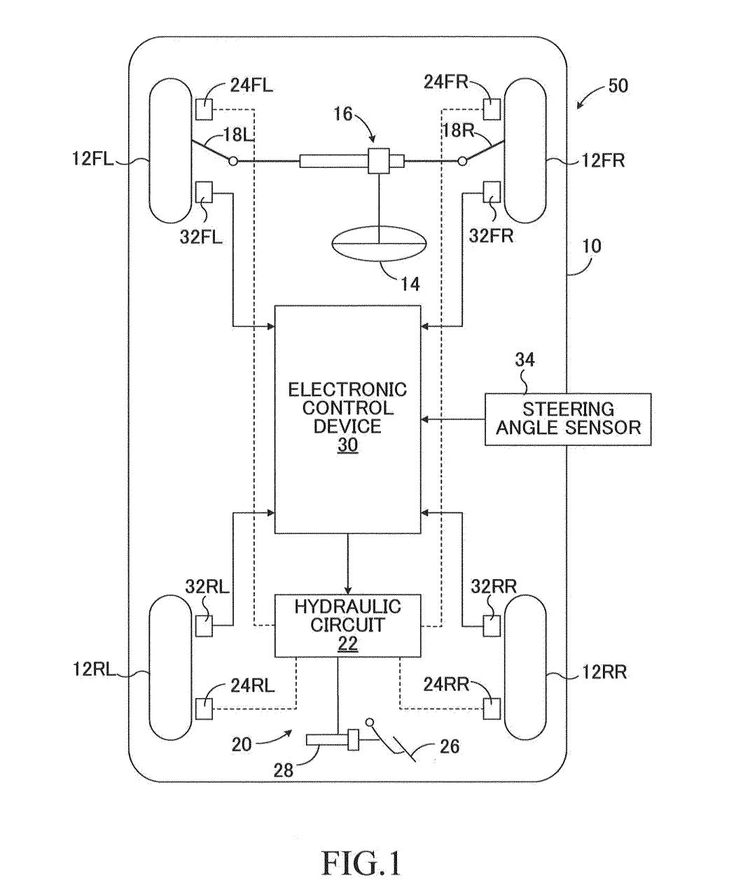

FIG. 1 is a schematic configuration diagram for illustrating a travel motion control device according to a first embodiment of the present invention configured to stabilize a travel motion of a vehicle by controlling braking forces of wheels.

In FIG. 1, the overall travel motion control device applied to a vehicle 10 is represented by reference numeral 50, and the vehicle 10 includes front left and right wheels 12FL and 12FR and rear left and right wheels 12RL and 12RR. The front left and right wheels 12FL and 12FR, which are steered wheels, are steered via tie rods 18L and 18R by a power steering device 16 of the rack-and-pinion type driven in response to an operation by a driver on a steering wheel 14. It should be noted that, in the illustrated embodiment, the vehicle 10 is a minivan, but may be any vehicle such as a bus or a truck having large variation ranges of a magnitude and a position of a movable load.

Braking forces of the respective wheels are controlled by controlling braking pressures of wheel cylinders 24FR, 24FL, 24RR, and 24RL by a hydraulic circuit 22 of a braking device 20. The hydraulic circuit 22 includes an oil reservoir, an oil pump, and various valve devices, which is not shown. The braking pressure in the each wheel cylinder is controlled by a master cylinder 28 driven in response to a depressing operation on a brake pedal 26 by the driver in a normal state, and is also controlled by an electronic control device 30 depending on necessity as described later.

Wheel speed sensors 32FR to 32RL for detecting wheel speeds Vwi (i=fr, fl, rr, and rl) of the corresponding wheels are arranged on the wheels 12FR to 12RL, and a steering angle sensor 34 for detecting a steering angle θ is arranged on a steering column coupled to the steering wheel 14. The steering angle sensor 34 detects the steering angle with a left turn direction of the vehicle being positive. It should be noted that FR, FL, RR, and RL, and fr, fl, rr, and rl respectively represent the front right wheel, the front left wheel, the rear right wheel, and the rear left wheel.

As illustrated, signals representing the wheel speeds Vwi detected by the wheel speed sensors 32FR to 32RL, and a signal representing the steering angle θ detected by the steering angle sensor 34 are input to the electronic control device 30.

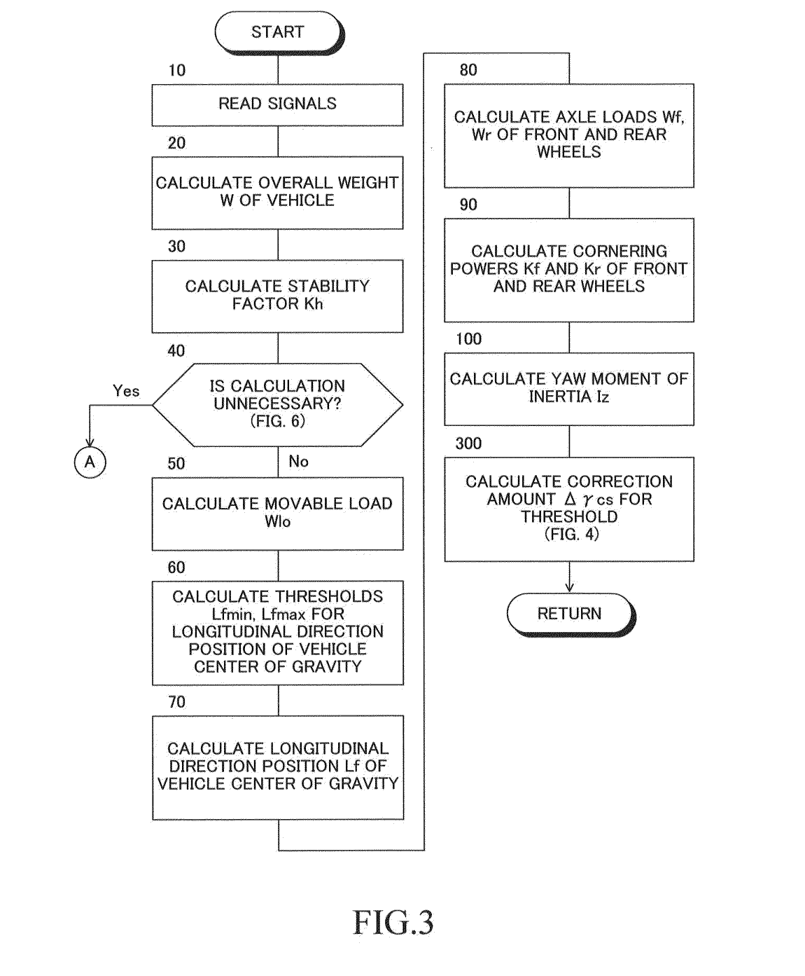

The electronic control device 30 includes a microcomputer having a typical configuration that includes, for example, a CPU, a ROM, an EEPROM, a RAM, a buffer memory, and an input/output port device, and in which those components are connected to one another via a bidirectional common bus, which is not illustrated in detail. The ROM stores flowcharts illustrated in FIG. 3 to FIG. 5, and various values for a standard state of the vehicle described later.

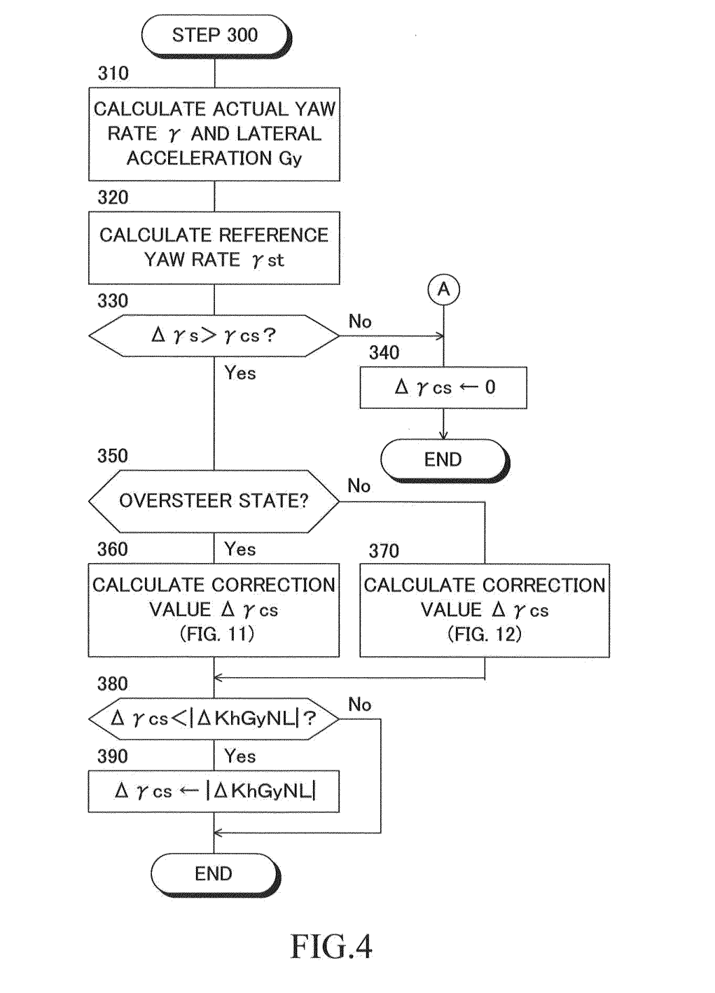

The electronic control device 30 follows the flowcharts illustrated in FIG. 3 and FIG. 4 as described later to calculate an overall weight W of the vehicle and a stability factor Kh of the vehicle, and uses a two-wheel model of the vehicle based thereon to calculate an actual yaw rate γ of the vehicle and a reference yaw rate γst. Moreover, when a magnitude of a steering angle conversion value Δγs of a magnitude of a deviation Δγ between the actual yaw rate γ and the reference yaw rate γst is larger than a threshold γcs (positive constant) for the travel motion control, the electronic control device 30 calculates a correction amount Δγcs for the threshold γcs. Then, the electronic control device 30 adds the correction amount Δγcs to the threshold γcs, to thereby correct the threshold.

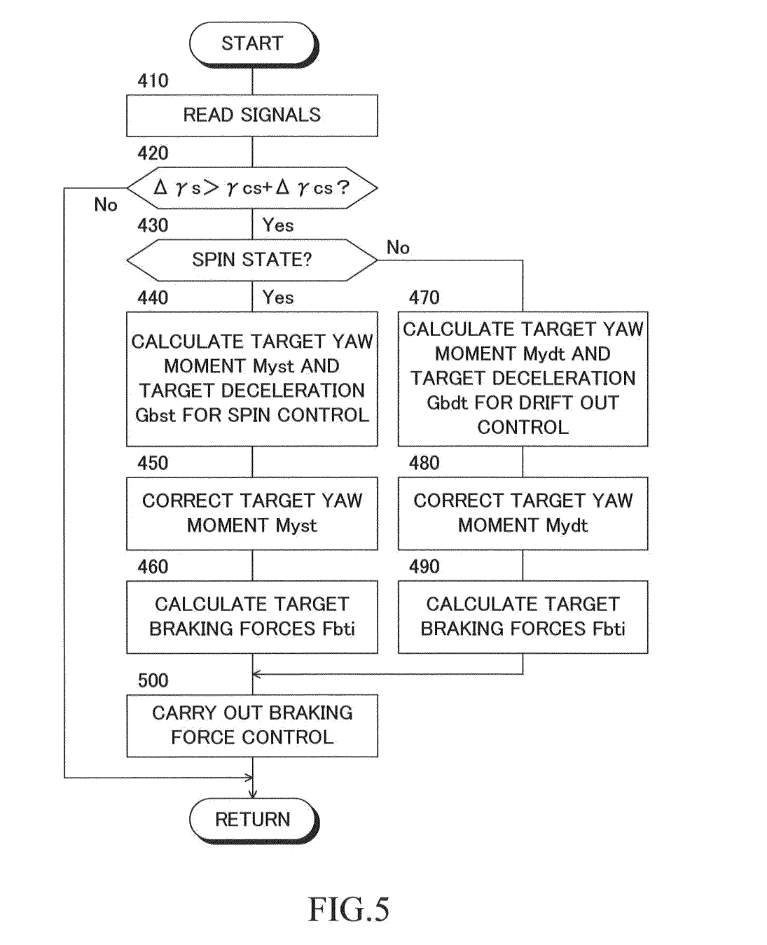

Moreover, the electronic control device 30 follows the flowchart illustrated in FIG. 5 as described later to determine whether or not the steering angle conversion value Δγs is larger than the corrected threshold γcs+Δγcs, to thereby determine whether or not a turn behavior of the vehicle is degraded, and the turn motion of the vehicle thus needs to be stabilized. Further, when the electronic control device 30 determines that the turn motion needs to be stabilized, the electronic control device 30 controls the braking forces of the respective wheels so as to stabilize the turn motion of the vehicle.

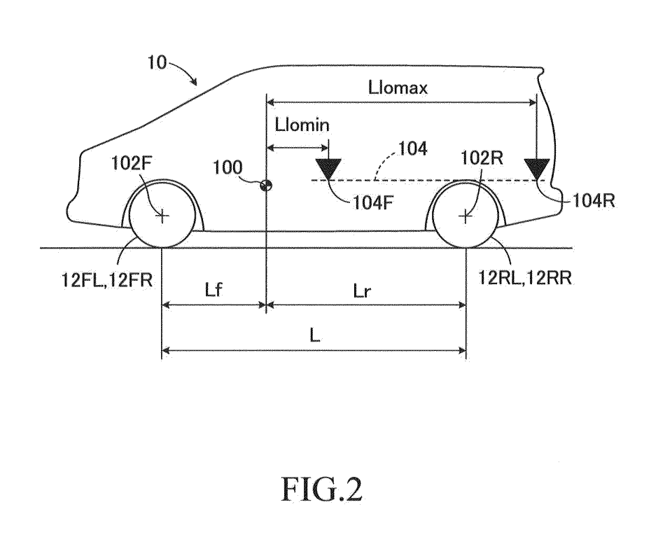

FIG. 2 is a side view for illustrating specifications such as a wheelbase of the vehicle. As illustrated in FIG. 2, the center of gravity 100 of the vehicle 10 is in an area of the wheelbase L of the vehicle 10. In other words, the center of gravity 100 exists between an axle 102F of the front wheels 12FL and 12FR and an axle 102R of the rear wheels 12RL and 12RR. Reference numerals Lf and Lr respectively denote a distance in the vehicle longitudinal direction between the center of gravity 100 and the axle 102F of the front wheels, and a distance between the center of gravity 100 and the axle 102R of the rear wheels. Moreover, reference symbols Llomin and Llomax respectively denote a distance in the vehicle longitudinal direction between the center of gravity 100 and a front end 104F of a cargo bed 104 and a distance in the vehicle longitudinal direction between the center of gravity 100 and a rear end 104R of the cargo bed 104, and those values are known.

Now, referring to flowcharts illustrated in FIG. 3 and FIG. 4, a description is given of a routine of calculating the correction amount Δγcs for the threshold for the travel motion control according to the first embodiment. It should be noted that the control in accordance with the flowcharts illustrated in FIG. 3 and FIG. 4 is started by closing of an ignition switch, which is not shown in the diagram, and is repeated at a predetermined period. This holds true for the travel motion control of the vehicle in accordance with the flowchart illustrated in FIG. 5 described later.

First, in Step 10, the signal representing the steering angle θ detected by the steering angle sensor 34 and the like are read.

In Step 20, based on a braking/driving force of the vehicle and an acceleration/deceleration of the vehicle, the overall weight W[kg] of the vehicle is calculated as an estimated value. In this case, for example, a procedure disclosed in Japanese Patent Application Laid-open No. 2002-33365 filed by the present applicant may be employed. In other words, the overall weight of the vehicle may be calculated in consideration of a travel resistance of the vehicle based on the driving force of the vehicle and the acceleration of the vehicle.

In Step 30, based on a state amount during a turn of the vehicle, a stability factor Kh of the vehicle is calculated as an estimated value. In this case, for example, a procedure disclosed in Japanese Patent Application Laid-open No. 2004-26073 filed by the present applicant may be employed. In other words, the estimated value of the stability factor Kh of the vehicle may be calculated by estimating a parameter of a transfer function from the normative yaw rate of the vehicle to the actual yaw rate.

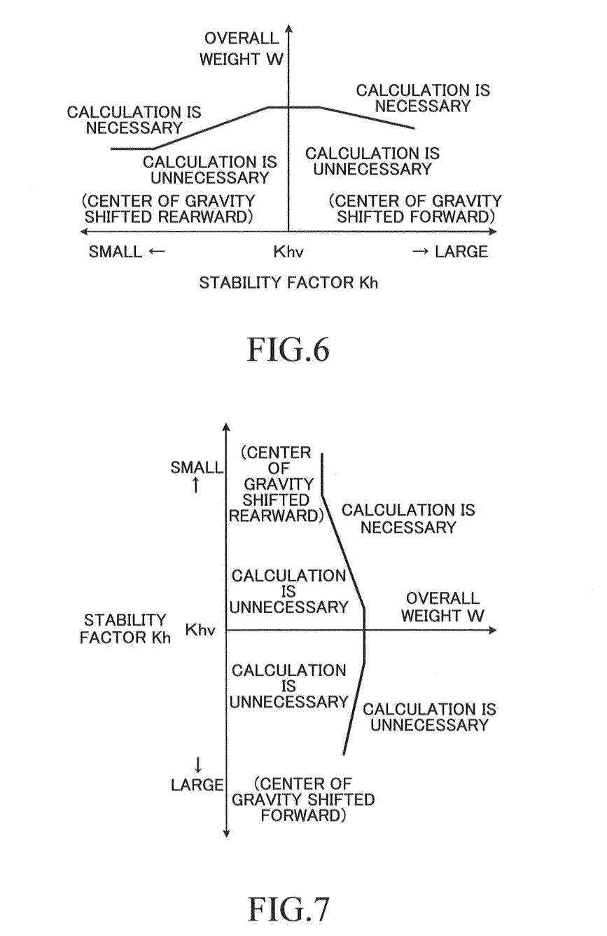

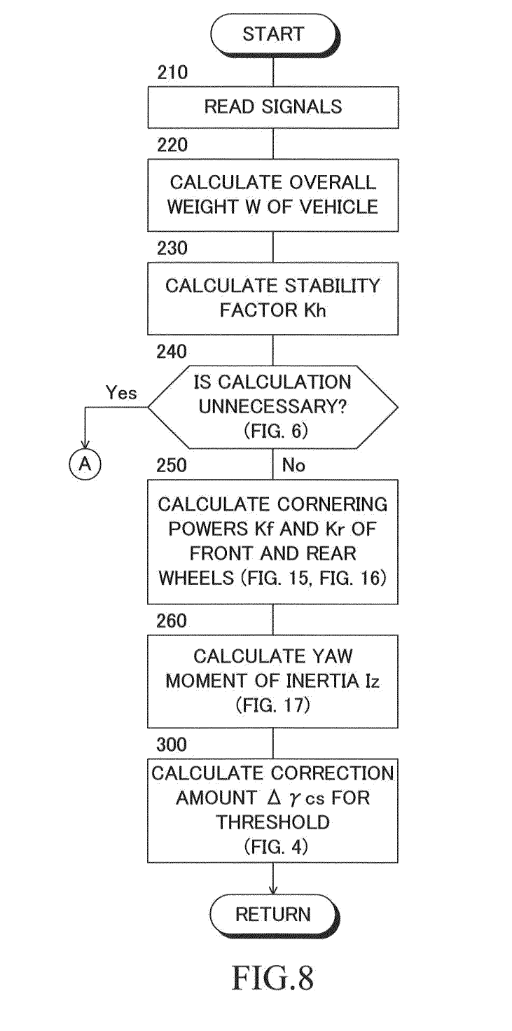

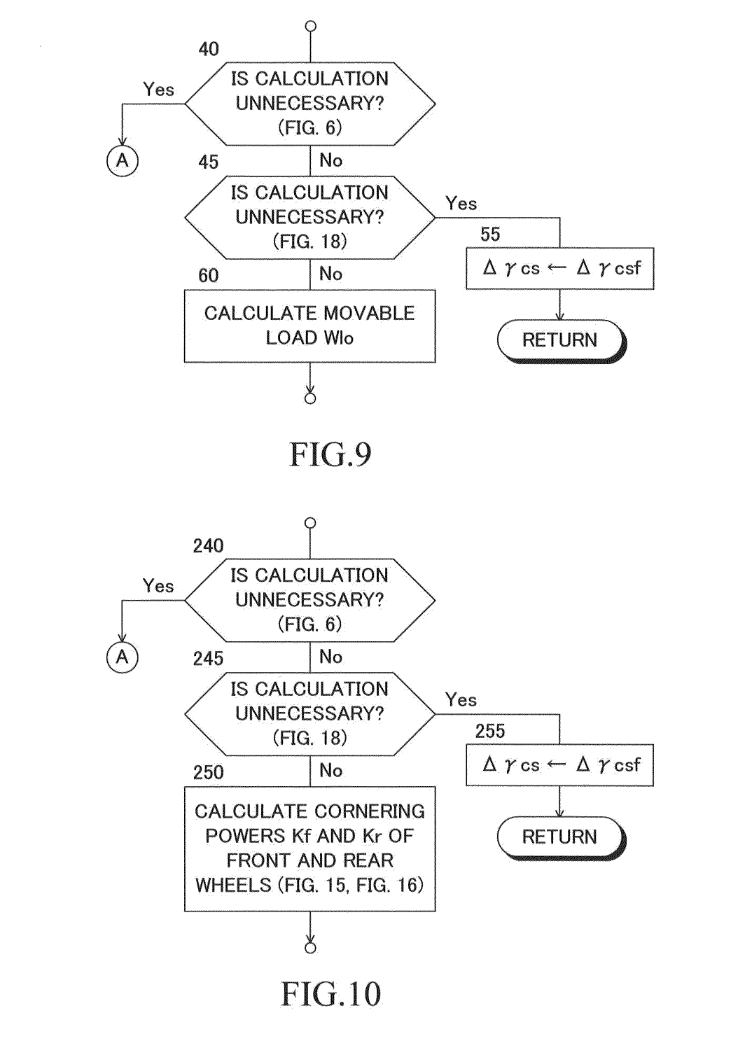

In Step 40, whether or not the calculation of the correction amount Δγcs for the threshold is unnecessary is determined using a map illustrated in FIG. 6 based on the estimated overall weight W and stability factor Kh of the vehicle. Then, when an affirmative determination is made, the control proceeds to Step 320 of FIG. 4, and when a negative determination is made, the control proceeds to Step 50.

It should be noted that, in Step 40, as illustrated in FIG. 6, whether or not the overall weight W of the vehicle is equal to or less than a threshold determined by the stability factor Kh of the vehicle is determined. However, as illustrated in FIG. 7, whether or not the stability factor Kh of the vehicle is equal to or less than a threshold determined by the overall weight W of the vehicle may be determined.

In Step 50, the standard weight of the vehicle is set to Wv[kg], and a movable load Wlo[kg] of the vehicle, which is a change amount of the weight of the vehicle with respect to the standard weight Wv is calculated in accordance with Expression (3). It should be noted that the standard weight Wv may be a weight of the vehicle in a standard state of the vehicle without the movable load, for example, in a state in which two persons are seated on a driver seat and a passenger seat.

Wlo=W−Wv (3)

In Step 60, based on the standard weight Wv and the movable load Wlo of the vehicle, the minimum threshold Lfmin[m] and the maximum threshold Lfmax[m] of the vehicle longitudinal direction position of the center of gravity 100 of the vehicle are calculated in accordance with Expressions (4) and (5), respectively. It should be noted that the minimum threshold Lfmin[m] and the maximum threshold Lfmax[m] of the vehicle longitudinal direction position of the center of gravity may be calculated by using a map, which is not shown, based on the overall weight W and the movable load Wlo of the vehicle.

$$\begin{matrix}Lf min = \frac{WvLfv + WIoLIo min}{Wv + WIo} & ( 4 ) \\ Lf max = \frac{WvLfv + WIoLIo max}{Wv + WIo} & ( 5 )\end{matrix}$$

In Step 70, based on the overall weight W and the stability factor Kh of the vehicle, a distance Lf[m] in the vehicle longitudinal direction between the center of gravity 100 of the vehicle and the axle 102F of the front wheels is calculated. The calculation of the distance Lf in this case may be carried out in a way disclosed, for example, in WO2010/082288 filed by the present applicant. Moreover, when the calculated value of the distance Lf is smaller than the minimum threshold Lfmin, the calculated value is corrected to the minimum threshold Lfmin, and when the calculated value of the distance Lf is larger than the maximum threshold Lfmax, the calculated value is corrected to the maximum threshold Lfmax, thereby applying guard processing of preventing the calculated value from exceeding a range between the thresholds.

In Step 80, a distance Lr (=L−Lf) [m] between the center of gravity 100 of the vehicle and the axle 102R of the rear wheels is calculated. Moreover, based on the overall weight W of the vehicle and the distances Lr and Lf between the center of gravity of the vehicle and the axles, an axle load Wf[kg] of the front wheels and an axle load Wr [kg] of the rear wheels are calculated respectively in accordance with Expressions (6) and (7).

Wf=WLr/L (6)

Wr=WLf/L (7)

In Step 90, based on the axle load Wf of the front wheels and the axle load Wr of the rear wheels, the cornering powers Kf and Kr of the tires of the front wheel and the rear wheel in a two-wheel model of the vehicle is calculated. The calculation of the cornering powers Kf and Kr in this case may be carried out in a way disclosed, for example, in WO2010/082288 filed by the present applicant.

In Step 100, the yaw moment of inertia Iz[kgm²] of the vehicle is calculated based on the overall weight W of the vehicle, the movable load Wlo (weight of the movable load) of the vehicle, the distance Lf, the standard weight of the vehicle Wv, and a distance Lfv between the center of gravity of the vehicle and the axle of the front wheel in the standard state of the vehicle.

For example, the axle load of the rear wheel in the standard state of the vehicle is denoted by Wry (known value), and first, a change amount ΔWr (=Wr−Wrv) of the axle load Wr of the rear wheel caused by the movable load is calculated. Then, based on the weight Wlo of the movable load and the change amount ΔWr of the axle load Wr of the rear wheel, a distance Lflo[m] in the vehicle longitudinal direction between the center of gravity 108 of the movable load 106 and the axle 102F of the front wheel is calculated in accordance with Expression (8). It should be noted that guard processing is applied to the distance Lflo so as not to exceed the above-mentioned range between the minimum threshold Lfmin and the maximum threshold Lfmax.

Lflo=LΔWr/Wlo (8)

Moreover, it is assumed that the center of gravity of the vehicle is at the center of gravity when a movable load exists, and a yaw moment of inertia Izv[kgm²] of the vehicle and a yaw moment of inertia Izlo[kgm²] of the movable load in the standard state are respectively calculated in accordance with Expressions (9) and (10). It should be noted that Izv0 is the yaw moment of inertia Iz of the vehicle in the standard state of the vehicle. Moreover, Plo is a weight proportional term, namely, a coefficient multiplied to the movable load in order to acquire the yaw moment of inertia only for the movable load.

Izv=Izv0+Wv(Lf−Lfv)² (9)

Izlo=WloPlo+Wlo(Lf−Lflo)² (10)

Further, the yaw moment of inertia Iz[kgm²] of the vehicle is calculated in accordance with Expression (11) based on the yaw moments of inertia Izv and Izlo of the vehicle and the movable load.

Iz=Izv+Izlo (11)

In Step 300 carried out after Step 100, the correction amount Δγcs for the threshold for the travel motion control is calculated in accordance with the flowchart illustrated in FIG. 4 as detailed later.

In Step 310 of the flowchart illustrated in FIG. 4, the vehicle speed V is calculated based on the wheel speeds Vwi. Moreover, the actual yaw rate γ of the vehicle and the lateral acceleration Gy of the vehicle are calculated by using the two-wheel model of the vehicle based on the vehicle speed V and the steering angle θ. In this case, the distance Lf of the two-wheel model, the cornering powers Kf and Kr, and the yaw moment of inertia Iz of the vehicle are respectively set to the values calculated in Steps 70, 90, and 100.

In Step 320, an actual steering angle δ of the front wheel is calculated based on the steering angle θ. Then, the reference yaw rate γst of the vehicle is calculated in accordance with Expression (1) based on the actual steering angle δ of the front wheel, and the vehicle speed V and the lateral acceleration Gy of the vehicle calculated in Step 310.

In Step 330, the steering angle conversion value Δγs of the magnitude of the deviation Δγ (=γ−γst) between the actual yaw rate γ and the reference yaw rate γst of the vehicle, namely, a value acquired by converting the absolute value of the deviation Δγ into the steering angle, is calculated in accordance with Expression (12) where a steering gear ratio is denoted by N.

Δγs=|γ−γst|NL/V (12)

Whether or not the wheel is in a grip-off state is determined by determining whether or not the steering angle conversion value Δγs exceeds a standard reference value γcs (positive value). Then, when an affirmative determination is made, the control proceeds to Step 350, and when a negative determination is made, in Step 340, the correction amount Δγcs for the threshold is set to 0, and then the control is tentatively finished. It should be noted that the reference value γcs is set by considering a gain error, a zero point error, and the like of the each sensor, an estimation error of the stability factor Kh, and the like.

In Step 350, based on a relationship between the sign of the actual yaw rate γ and the sign of the yaw rate deviation Δγ, whether or not the vehicle is in an oversteer state is determined. Then, when a negative determination is made, in other words, it is determined that the vehicle is in the understeer state, the control proceeds to Step 370, and when an affirmative determination is made, the control proceeds to Step 360.

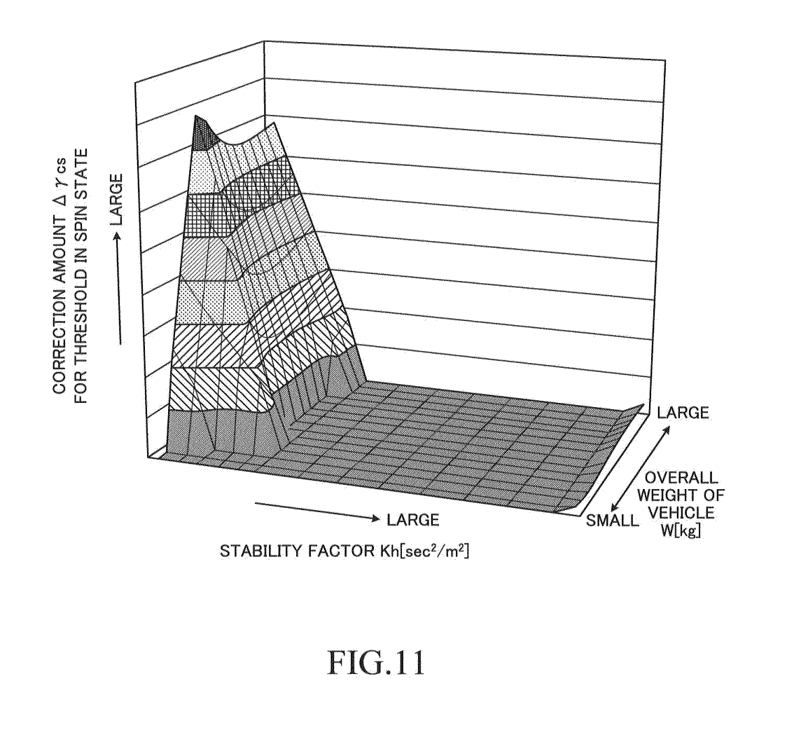

In Step 360, the correction amount Δγcs for the threshold when the vehicle is in a spin state is calculated using a map shown in FIG. 11 based on the overall weight W and the stability factor Kh of the vehicle calculated in Steps 20 and 30.

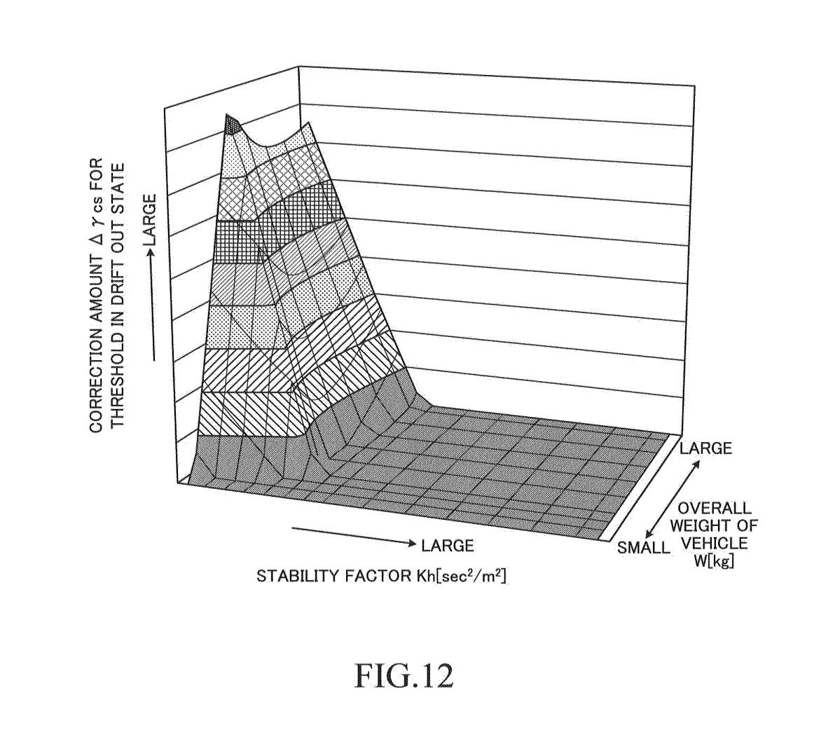

In Step 370, the correction amount Δγcs for the threshold when the vehicle is in the drift out state is calculated using a map illustrated in FIG. 12 based on the overall weight W and the stability factor Kh of the vehicle calculated in Steps 20 and 30.

In Step 380, a deviation ΔKh (=Kh−Khv) between the stability factor Kh of the vehicle calculated in Step 30 and a stability factor Khv when the vehicle is in the standard state is calculated. Then, whether or not an absolute value |ΔKhGyNL| of a product of the deviation ΔKh, the lateral acceleration Gy of the vehicle, the steering gear ratio N, and the wheelbase L of the vehicle is larger than the correction amount Δγcs is determined. Then, when a negative determination is made, the control is tentatively finished, and when an affirmative determination is made, in Step 390, the correction amount Δγcs for the threshold is set to the absolute value |ΔKhGyNL| of the product.

It should be noted that a correction amount Δγcsf for the threshold is a correction amount for preventing an unnecessary determination that the turn travel motion of the vehicle is degraded when a magnitude of the steering frequency is large, and when a deviation in the phase between the yaw rate and the lateral acceleration of the vehicle is large. In contrast, the product ΔKhGyNL is a value acquired by converting the deviation ΔKh of the stability factor into the steering angle. This value is a correction amount for preventing the unnecessary determination that the turn travel motion of the vehicle is degraded when the magnitude of the steering frequency is not large.

Referring to the flowchart illustrated in FIG. 5, a description is now given of travel motion control of the vehicle carried out by using the correction amount Δγcs for the threshold.

First, in Step 410, a signal representing the steering angle conversion value Δγs of the magnitude of the yaw rate deviation Δγ calculated as described above and a signal representing the correction amount Δγcs for the threshold are read.

In Step 420, whether or not the turn behavior of the vehicle is degraded is determined by determining whether or not the steering angle conversion value Δγs of the magnitude of the yaw rate deviation exceeds the sum γcs+Δγcs of the reference value γcs and the correction amount Δγcs, namely, the corrected threshold. Then, when a negative determination is made, the control is tentatively finished, and when an affirmative determination is made, the control proceeds to Step 430.

In Step 430, based on a relationship between the sign of the actual yaw rate γ and the sign of the yaw rate deviation Δγ, whether or not the vehicle is in a spin state (oversteer state) is determined. Then, when a negative determination is made, that is, when the vehicle is determined to be in the drift out state, the control proceeds to Step 470, and when an affirmative determination is made, the control proceeds to Step 440.

In Step 440, a slip angle of the vehicle and the like are calculated, and a spin state amount SS representing a degree of the spin state of the vehicle is calculated based on the slip angle of the vehicle and the like. Then, a target yaw moment Mγst and a target deceleration Gbst are calculated using maps, which are not shown and set in advance for the standard state of the vehicle, based on the spin state amount SS and a turn direction of the vehicle.

In Step 450, the target yaw moment Mγst is corrected to Iz/Izv times the value thereof in accordance with Expression (13).

Myst←Myst(Iz/Izv) (13)

In Step 460, based on the target yaw moment Mγst after the correction and the target deceleration Gbst, target braking forces Fbti (i=fr, fl, rr, and rl) for the respective wheels for mitigating the spin state of the vehicle are calculated.

In Step 470, a drift out state amount DS representing a degree of a drift out state (understeer state) of the vehicle is calculated based on the yaw rate deviation Δγ and the like. Then, a target yaw moment Mydt and a target deceleration Gbdt are calculated using maps, which are not shown and set in advance for the standard state of the vehicle, based on the drift out state amount DS and the turn direction of the vehicle.

In Step 480, the target yaw moment Mydt is corrected to Iz/Izv times the value thereof in accordance with Expression (14).

Mydt←Mydt(Iz/Izv) (14)

In Step 490, based on the target yaw moment Mydt after the correction and the target deceleration Gbdt, the target braking forces Fbti (i=fr, fl, rr, and rl) for the respective wheels for mitigating the drift out state of the vehicle are calculated.

In Step 500, a slip ratio of the each wheel is controlled by control of the braking pressure for the each wheel so that a braking force Fbi of the each wheel reaches the corresponding target braking force Fbti, and as a result, the spin state or the drift out state of the vehicle is mitigated. It should be noted that the braking force of the each wheel may be attained by calculating a target braking pressure of the each wheel based on the target braking force Fbti, and controlling a braking pressure of the each wheel to reach the corresponding target braking pressure.

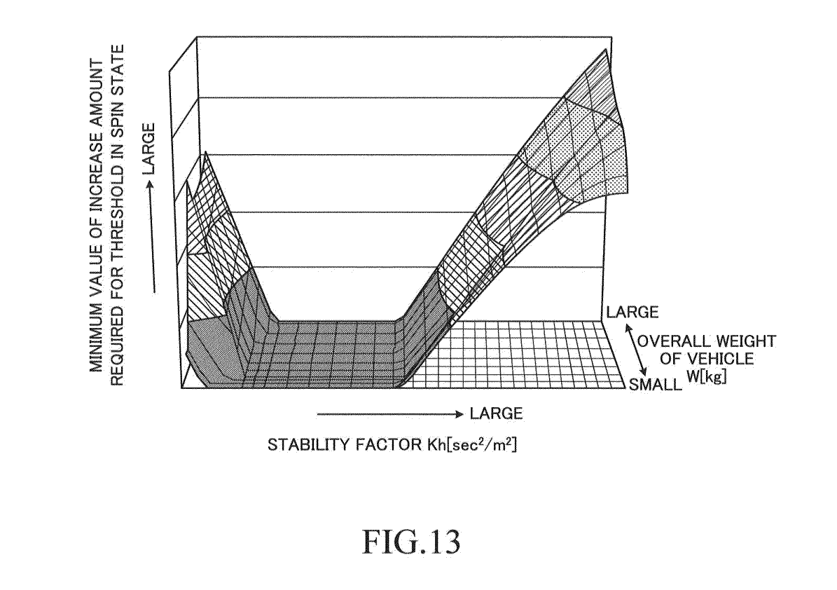

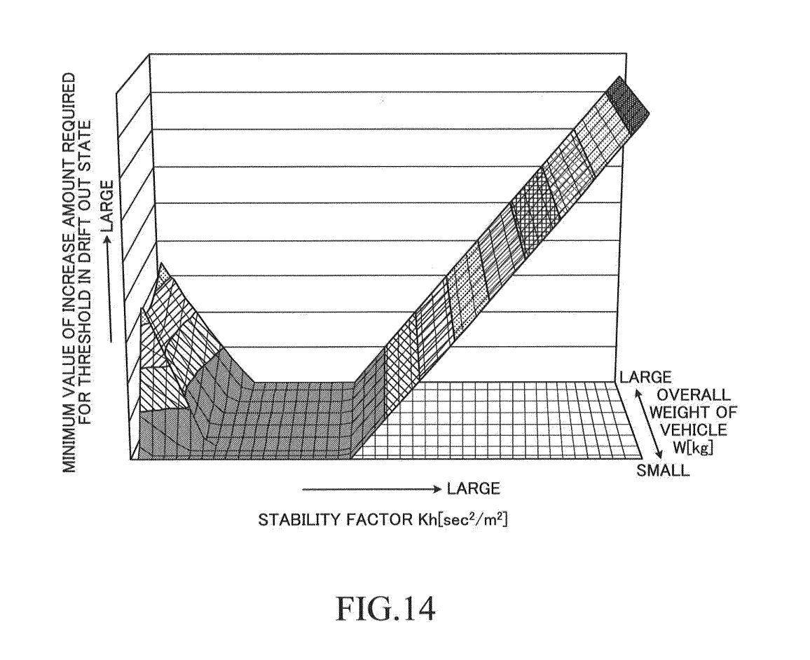

Then, referring to Tables 1 to 25 and FIG. 13 and FIG. 14, a description is now given of the maps illustrated in FIG. 11 and FIG. 12 for calculating the correction amount Δγcs for the threshold. It should be noted that, in Tables 1 to 25, there are represented various values calculated offline for a model of the vehicle in which the overall weight W is 3,000 [kg], and the stability factor Kh is 120×10⁻⁵ [sec/m²].

In Tables 1 to 5, a relationship among the vehicle speed V [km/h], the steering frequency Fs [Hz], and the maximum steering angle θ [deg] is shown for cases where the lateral acceleration Gy [m/sec²] of the vehicle are respectively 1.0, 2.0, 3.0, 4.0, and 5.0.

TABLE 1
Gy = 1.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 110 | 112 | 115 | 117 | 116 |
| 40 | 31 | 34 | 42 | 56 | 76 |
| 60 | 16 | 18 | 25 | 38 | 64 |
| 80 | 11 | 12 | 18 | 30 | 59 |
| 100 | 8 | 9 | 14 | 26 | 55 |
| 120 | 7 | 8 | 12 | 24 | 54 |
| 140 | 6 | 6 | 10 | 22 | 52 |
| 160 | 6 | 6 | 9 | 21 | 52 |
| 180 | 5 | 5 | 9 | 21 | 51 |

TABLE 2
Gy = 2.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 214 | 217 | 223 | 226 | 224 |
| 40 | 62 | 69 | 84 | 112 | 152 |
| 60 | 32 | 37 | 50 | 76 | 128 |
| 80 | 21 | 25 | 36 | 61 | 117 |
| 100 | 16 | 19 | 28 | 53 | 111 |
| 120 | 14 | 15 | 24 | 48 | 107 |
| 140 | 12 | 13 | 21 | 45 | 105 |
| 160 | 11 | 11 | 19 | 43 | 103 |
| 180 | 10 | 10 | 17 | 41 | 102 |

TABLE 3
Gy = 3.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 315 | 321 | 329 | 334 | 331 |
| 40 | 92 | 103 | 126 | 166 | 221 |
| 60 | 48 | 55 | 74 | 115 | 188 |
| 80 | 32 | 37 | 53 | 91 | 173 |
| 100 | 25 | 28 | 42 | 79 | 165 |
| 120 | 21 | 23 | 36 | 72 | 160 |
| 140 | 18 | 19 | 31 | 67 | 156 |
| 160 | 17 | 17 | 28 | 64 | 154 |
| 180 | 15 | 15 | 26 | 62 | 153 |

TABLE 4
Gy = 4.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 412 | 418 | 428 | 434 | 431 |
| 40 | 123 | 137 | 167 | 217 | 292 |
| 60 | 64 | 74 | 99 | 152 | 248 |
| 80 | 43 | 50 | 71 | 122 | 227 |
| 100 | 33 | 38 | 56 | 106 | 215 |
| 120 | 28 | 30 | 47 | 96 | 208 |
| 140 | 24 | 26 | 41 | 90 | 204 |
| 160 | 22 | 22 | 37 | 85 | 201 |
| 180 | 20 | 20 | 34 | 82 | 198 |

TABLE 5
Gy = 5.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 502 | 509 | 521 | 528 | 524 |
| 40 | 154 | 169 | 205 | 269 | 360 |
| 60 | 80 | 92 | 124 | 187 | 307 |
| 80 | 54 | 62 | 89 | 152 | 281 |
| 100 | 41 | 47 | 71 | 132 | 267 |
| 120 | 34 | 38 | 59 | 120 | 258 |
| 140 | 30 | 32 | 52 | 112 | 253 |
| 160 | 28 | 28 | 47 | 107 | 249 |
| 180 | 26 | 25 | 43 | 103 | 246 |

Moreover, in Tables 6 to 10, a case (0) in which the determination of the grip-off of the oversteer is not made and a case (1) in which this determination is made are shown for each of the cases shown in Tables 1 to 5.

TABLE 6
Gy = 1.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 0 | 0 | 0 |
| 40 | 0 | 0 | 0 | 0 | 0 |
| 60 | 0 | 0 | 0 | 0 | 0 |
| 80 | 0 | 0 | 0 | 0 | 0 |
| 100 | 0 | 0 | 0 | 0 | 0 |
| 120 | 0 | 0 | 0 | 0 | 0 |
| 140 | 0 | 0 | 0 | 0 | 0 |
| 160 | 0 | 0 | 0 | 0 | 0 |
| 180 | 0 | 0 | 0 | 0 | 0 |

TABLE 7
Gy = 2.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 0 | 0 | 0 |
| 40 | 0 | 0 | 0 | 0 | 1 |
| 60 | 0 | 0 | 0 | 0 | 0 |
| 80 | 0 | 0 | 0 | 0 | 0 |
| 100 | 0 | 0 | 0 | 0 | 0 |
| 120 | 0 | 0 | 0 | 0 | 0 |
| 140 | 0 | 0 | 0 | 0 | 0 |
| 160 | 0 | 0 | 0 | 0 | 0 |
| 180 | 0 | 0 | 0 | 0 | 0 |

TABLE 8
Gy = 3.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 1 | 1 | 1 |
| 40 | 0 | 0 | 0 | 1 | 1 |
| 60 | 0 | 0 | 0 | 1 | 1 |
| 80 | 0 | 0 | 0 | 0 | 1 |
| 100 | 0 | 0 | 0 | 0 | 0 |
| 120 | 0 | 0 | 0 | 0 | 0 |
| 140 | 0 | 0 | 0 | 0 | 0 |
| 160 | 0 | 0 | 0 | 0 | 0 |
| 180 | 0 | 0 | 0 | 0 | 0 |

TABLE 9
Gy = 4.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 1 | 1 | 1 | 1 |
| 40 | 0 | 0 | 1 | 1 | 1 |
| 60 | 0 | 0 | 1 | 1 | 1 |
| 80 | 0 | 0 | 0 | 1 | 1 |
| 100 | 0 | 0 | 0 | 0 | 1 |
| 120 | 0 | 0 | 0 | 0 | 0 |
| 140 | 0 | 0 | 0 | 0 | 0 |
| 160 | 0 | 0 | 0 | 0 | 0 |
| 180 | 0 | 0 | 0 | 0 | 0 |

TABLE 10
Gy = 5.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 1 | 1 | 1 | 1 |
| 40 | 0 | 1 | 1 | 1 | 1 |
| 60 | 0 | 0 | 1 | 1 | 1 |
| 80 | 0 | 0 | 1 | 1 | 1 |
| 100 | 0 | 0 | 0 | 0 | 1 |
| 120 | 0 | 0 | 0 | 0 | 0 |
| 140 | 0 | 0 | 0 | 0 | 0 |
| 160 | 0 | 0 | 0 | 0 | 0 |
| 180 | 0 | 0 | 0 | 0 | 0 |

Similarly, in Tables 11 to 15, a case (0) in which the determination of the grip-off of the understeer is not determined and a case (1) in which this determination is made are shown for each of the cases shown in Tables 1 to 5.

TABLE 11
Gy = 1.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 0 | 0 | 0 |
| 40 | 0 | 0 | 0 | 0 | 0 |
| 60 | 0 | 0 | 0 | 0 | 0 |
| 80 | 0 | 0 | 0 | 0 | 0 |
| 100 | 0 | 0 | 0 | 0 | 0 |
| 120 | 0 | 0 | 0 | 0 | 0 |
| 140 | 0 | 0 | 0 | 0 | 0 |
| 160 | 0 | 0 | 0 | 0 | 0 |
| 180 | 0 | 0 | 0 | 0 | 0 |

TABLE 12
Gy = 2.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 0 | 0 | 0 |
| 40 | 0 | 0 | 0 | 0 | 1 |
| 60 | 0 | 0 | 0 | 0 | 1 |
| 80 | 0 | 0 | 0 | 0 | 1 |
| 100 | 0 | 0 | 0 | 0 | 1 |
| 120 | 0 | 0 | 0 | 0 | 1 |
| 140 | 0 | 0 | 0 | 0 | 0 |
| 160 | 0 | 0 | 0 | 0 | 0 |
| 180 | 0 | 0 | 0 | 0 | 0 |

TABLE 13
Gy = 3.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 0 | 1 | 1 |
| 40 | 0 | 0 | 0 | 1 | 1 |
| 60 | 0 | 0 | 0 | 1 | 1 |
| 80 | 0 | 0 | 0 | 1 | 1 |
| 100 | 0 | 0 | 0 | 1 | 1 |
| 120 | 0 | 0 | 0 | 1 | 1 |
| 140 | 0 | 0 | 0 | 0 | 1 |
| 160 | 0 | 0 | 0 | 0 | 1 |
| 180 | 0 | 0 | 0 | 0 | 1 |

TABLE 14
Gy = 4.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 1 | 1 | 1 |
| 40 | 0 | 0 | 1 | 1 | 1 |
| 60 | 0 | 0 | 1 | 1 | 1 |
| 80 | 0 | 0 | 1 | 1 | 1 |
| 100 | 0 | 0 | 1 | 1 | 1 |
| 120 | 0 | 0 | 0 | 1 | 1 |
| 140 | 0 | 0 | 0 | 1 | 1 |
| 160 | 0 | 0 | 0 | 1 | 1 |
| 180 | 0 | 0 | 0 | 1 | 1 |

TABLE 15
Gy = 5.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 1 | 1 | 1 | 1 |
| 40 | 0 | 0 | 1 | 1 | 1 |
| 60 | 0 | 0 | 1 | 1 | 1 |
| 80 | 0 | 0 | 1 | 1 | 1 |
| 100 | 0 | 0 | 1 | 1 | 1 |
| 120 | 0 | 0 | 1 | 1 | 1 |
| 140 | 0 | 0 | 1 | 1 | 1 |
| 160 | 0 | 0 | 1 | 1 | 1 |
| 180 | 0 | 0 | 0 | 1 | 1 |

In Tables 16 to 20, the minimum value of the increase amount of the threshold, namely, the correction amount Δγcs for the threshold, which is required for preventing the determination of the grip-off of the oversteer, namely, the spin state, is shown for each of the cases shown in Tables 6 to 10.

TABLE 16
Gy = 1.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 0 | 0 | 0 |
| 40 | 0 | 0 | 0 | 0 | 0 |
| 60 | 0 | 0 | 0 | 0 | 0 |
| 80 | 0 | 0 | 0 | 0 | 0 |
| 100 | 0 | 0 | 0 | 0 | 0 |
| 120 | 0 | 0 | 0 | 0 | 0 |
| 140 | 0 | 0 | 0 | 0 | 0 |
| 160 | 0 | 0 | 0 | 0 | 0 |
| 180 | 0 | 0 | 0 | 0 | 0 |

TABLE 17
Gy = 2.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 0 | 0 | 0 |
| 40 | 0 | 0 | 0 | 0 | 0 |
| 60 | 0 | 0 | 0 | 0 | 0 |
| 80 | 0 | 0 | 0 | 0 | 0 |
| 100 | 0 | 0 | 0 | 0 | 0 |
| 120 | 0 | 0 | 0 | 0 | 0 |
| 140 | 0 | 0 | 0 | 0 | 0 |
| 160 | 0 | 0 | 0 | 0 | 0 |
| 180 | 0 | 0 | 0 | 0 | 0 |

TABLE 18
Gy = 3.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 5 | 11 | 13 |
| 40 | 0 | 0 | 0 | 5 | 10 |
| 60 | 0 | 0 | 0 | 1 | 6 |
| 80 | 0 | 0 | 0 | 0 | 2 |
| 100 | 0 | 0 | 0 | 0 | 0 |
| 120 | 0 | 0 | 0 | 0 | 0 |
| 140 | 0 | 0 | 0 | 0 | 0 |
| 160 | 0 | 0 | 0 | 0 | 0 |
| 180 | 0 | 0 | 0 | 0 | 0 |

TABLE 19
Gy = 4.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 5 | 17 | 26 | 28 |
| 40 | 0 | 0 | 5 | 13 | 20 |
| 60 | 0 | 0 | 1 | 7 | 13 |
| 80 | 0 | 0 | 0 | 1 | 7 |
| 100 | 0 | 0 | 0 | 0 | 1 |
| 120 | 0 | 0 | 0 | 0 | 0 |
| 140 | 0 | 0 | 0 | 0 | 0 |
| 160 | 0 | 0 | 0 | 0 | 0 |
| 180 | 0 | 0 | 0 | 0 | 0 |

TABLE 20
Gy = 5.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 14 | 30 | 40 | 42 |
| 40 | 0 | 1 | 11 | 22 | 30 |
| 60 | 0 | 0 | 5 | 13 | 21 |
| 80 | 0 | 0 | 1 | 5 | 12 |
| 100 | 0 | 0 | 0 | 0 | 4 |
| 120 | 0 | 0 | 0 | 0 | 0 |
| 140 | 0 | 0 | 0 | 0 | 0 |
| 160 | 0 | 0 | 0 | 0 | 0 |
| 180 | 0 | 0 | 0 | 0 | 0 |

Similarly, in Tables 21 to 25, the minimum value of the increase amount of the threshold, namely, the correction amount Δγcs for the threshold, which is required for preventing the determination of the drift out, is shown for each of the cases shown in Tables 11 to 15. It should be noted that values shown in Tables 16 to 25 are integers, but may not be integers.

TABLE 21
Gy = 1.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 0 | 0 | 0 |
| 40 | 0 | 0 | 0 | 0 | 0 |
| 60 | 0 | 0 | 0 | 0 | 0 |
| 80 | 0 | 0 | 0 | 0 | 0 |
| 100 | 0 | 0 | 0 | 0 | 0 |
| 120 | 0 | 0 | 0 | 0 | 0 |
| 140 | 0 | 0 | 0 | 0 | 0 |
| 160 | 0 | 0 | 0 | 0 | 0 |
| 180 | 0 | 0 | 0 | 0 | 0 |

TABLE 22
Gy = 2.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 0 | 0 | 0 |
| 40 | 0 | 0 | 0 | 0 | 5 |
| 60 | 0 | 0 | 0 | 0 | 5 |
| 80 | 0 | 0 | 0 | 0 | 3 |
| 100 | 0 | 0 | 0 | 0 | 2 |
| 120 | 0 | 0 | 0 | 0 | 1 |
| 140 | 0 | 0 | 0 | 0 | 0 |
| 160 | 0 | 0 | 0 | 0 | 0 |
| 180 | 0 | 0 | 0 | 0 | 0 |

TABLE 23
Gy = 3.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 0 | 8 | 15 |
| 40 | 0 | 0 | 0 | 7 | 17 |
| 60 | 0 | 0 | 0 | 5 | 15 |
| 80 | 0 | 0 | 0 | 3 | 12 |
| 100 | 0 | 0 | 0 | 1 | 9 |
| 120 | 0 | 0 | 0 | 0 | 7 |
| 140 | 0 | 0 | 0 | 0 | 5 |
| 160 | 0 | 0 | 0 | 0 | 4 |
| 180 | 0 | 0 | 0 | 0 | 3 |

TABLE 24
Gy = 4.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 9 | 21 | 30 |
| 40 | 0 | 0 | 4 | 16 | 30 |
| 60 | 0 | 0 | 3 | 11 | 25 |
| 80 | 0 | 0 | 2 | 8 | 20 |
| 100 | 0 | 0 | 1 | 6 | 16 |
| 120 | 0 | 0 | 0 | 4 | 13 |
| 140 | 0 | 0 | 0 | 3 | 11 |
| 160 | 0 | 0 | 0 | 2 | 9 |
| 180 | 0 | 0 | 0 | 1 | 7 |

TABLE 25
Gy = 5.0 [m/s²]

| Vehicle speed V | Steering frequency Fs [Hz] | | | | |
|---|---|---|---|---|---|
| [km/h] | 0.1 | 0.3 | 0.5 | 0.7 | 0.9 |
| 20 | 0 | 0 | 19 | 33 | 41 |
| 40 | 0 | 0 | 10 | 24 | 42 |
| 60 | 0 | 0 | 8 | 18 | 35 |
| 80 | 0 | 0 | 6 | 14 | 29 |
| 100 | 0 | 0 | 4 | 11 | 24 |
| 120 | 0 | 0 | 3 | 8 | 19 |
| 140 | 0 | 0 | 2 | 6 | 16 |
| 160 | 0 | 0 | 1 | 5 | 13 |
| 180 | 0 | 0 | 0 | 3 | 11 |

When Tables 16 to 25 are produced, conditions for the vehicle speed V and the like so as to prevent the determination of the grip-off from being made unnecessarily early are set as described below so that values are in ranges of values that may be generated during a general travel of the vehicle. It should be noted that those conditions are not limited to the following values, and only need to be set appropriately depending on the vehicle and the travel state to which the present invention is applied.

Vehicle speed V: less than 100 [km/h]

Absolute value of lateral acceleration Gy: less than 3 [m/sec²]

Steering frequency Fs: less than 0.5 [Hz]

Absolute value of steering angle θ: less than 100 [deg]

As described above, in Tables 16 to 25, the correction amount Δγcs for the threshold acquired for the model of the vehicle in which the overall weight W is 3,000 [kg], and the stability factor Kh is 120×10⁻⁵ [sec/m²] is shown. Tables similar to Tables 16 to 25 can be acquired for cases where the overall weight W and the stability factor Kh take various values by carrying out calculations similar to the calculations of acquiring Tables 1 to 25 while the overall weight W and the stability factor Kh are set to various values.

In this way, the minimum values of the increase amount of the threshold required for preventing the determination of the spin state and the drift out state from being made can be acquired for various values of the overall weight W and the stability factor Kh. In FIG. 13 and FIG. 14, relationships between the minimum value of the increase amount of the threshold required for preventing the determination of the spin state and the drift out state from being made, and the overall weight W and the stability factor Kh are shown. Thus, based on the relationships shown in FIG. 13 and FIG. 14, as shown in FIG. 11 and FIG. 12, maps for calculating the correction amount Δγcs for the threshold based on the overall weight W and the stability factor Kh of the vehicle can be generated. In this case, ranges of the overall weight W and the stability factor Kh of the vehicle when the map is generated are determined depending on the vehicle to which the present invention is applied.

It should be noted that, as described above, as a result of the control carried out in Steps 380 and 390, when the absolute value of the product of the deviation ΔKh from the stability factor Khv is more than the correction amount Δγcs, the correction amount Δγcs for the threshold is set to the absolute value |ΔKhGyNL| of the product. Thus, regions where the correction amount Δγcs is zero out of the maps shown in FIG. 11 and FIG. 12 are regions in which the correction amount Δγcs may be set to the absolute value of the product of the deviation ΔKh.

As understood from the above description, according to the first embodiment, in Step 20, the overall weight W of the vehicle is calculated, in Step 30, the stability factor Kh of the vehicle is calculated, and in Step 50, the movable load Wlo of the vehicle is calculated. Moreover, in Step 70, the distance Lf in the vehicle longitudinal direction between the center of gravity 100 of the vehicle and the axle 102F of the front wheel is calculated, and in Step 80, the axle load Wf of the front wheel and the axle load Wr of the rear wheel are calculated. Then, in Step 90, the cornering powers Kf and Kr of the tires of the front wheel and the rear wheel are calculated based on the respective axle loads Wf and Wr. Moreover, in Step 100, the yaw moment of inertia Iz of the vehicle is calculated based on the movable load Wlo of the vehicle and the like.

Further, in Step 300, the correction amount Δγcs for the threshold for the travel motion control is calculated by using the yaw moment of inertia Iz of the vehicle calculated as described above and the like in accordance with the flowchart illustrated in FIG. 4.

Particularly, in Step 310, the two-wheel model in which the yaw moment of inertia Iz of the vehicle and the like are set to the values calculated as described above is used to calculate the actual yaw rate γ of the vehicle and the lateral acceleration Gy of the vehicle, and, in Step 320, the reference yaw rate γst of the vehicle is calculated. Then, in Step 330, the steering angle conversion value Δγs of the magnitude of the deviation Δγ between the actual yaw rate γ and the reference yaw rate γst of the vehicle is calculated, and whether or not the wheel is in the grip-off state is determined by determining whether or not the steering angle conversion value Δγs exceeds the reference value γcs.

When the wheel is determined to be in the grip-off state, in Steps 350 to 370, the correction amount Δγcs is calculated as the minimum value of the increase correction amount for the threshold for preventing the determination that the steering angle conversion value Δγs corresponding to the yaw rate deviation Δγ exceeds the reference value γcs. Then, in Step 420, the sum of the reference value γcs and the correction amount Δγcs is set to the corrected threshold, and whether or not the turn motion of the vehicle is degraded is determined by determining whether or not the steering angle conversion value Δγs exceeds the corrected threshold.

Thus, even when the overall weight of the vehicle and the vehicle longitudinal direction position of the vehicle center of gravity change, the unnecessarily early determination that the magnitude of the yaw rate deviation exceeds the threshold as a result of the calculation error in the reference yaw rate γst caused by those changes can be prevented. Thus, the fear for the unnecessarily early start of the control of the braking forces for stabilizing the travel motion of the vehicle can be effectively reduced. It should be noted that those actions and effects are similarly obtained in a second embodiment of the present invention described later.

Moreover, the correction amount Δγcs is the minimum value of the increase correction amount for the threshold for preventing the unnecessarily early start of the control of stabilizing the travel motion of the vehicle. Thus, the threshold for determining whether or not the turn motion of the vehicle is degraded is not corrected so as to excessively increase, and, as a result, even when the turn motion of the vehicle is degraded, the determination of the degradation is not delayed. It should be noted that those actions and effects are also similarly obtained in the second embodiment described later.

Particularly, according to the first embodiment, on the assumption that the center of gravity of the vehicle is at the center of gravity when the movable load exists, the yaw moment of inertia Izv of the vehicle in the standard state and the yaw moment of inertia Izlo of the movable load are calculated, and the sum thereof is calculated as the yaw moment of inertia Iz. Then, when the yaw moment of inertia Izlo of the movable load is calculated, the guard processing is applied to the distance Lflo in the vehicle longitudinal direction between the center of gravity of the movable load and the axle of the front wheels so as not to exceed the range between the minimum threshold Lfmin and the maximum threshold Lfmax.

Thus, according to the first embodiment, even when the overall weight of the vehicle and the vehicle longitudinal direction position of the vehicle center of gravity change, the yaw moment of inertia Iz of the vehicle reflecting the changes can reliably be estimated, thereby preventing Iz from being calculated to be an abnormal value.

### Second Embodiment

FIG. 8 is a flowchart for illustrating a routine of calculating the correction amount Δγcs for the threshold for the travel motion control of the travel motion control device according to the second embodiment of the present invention.

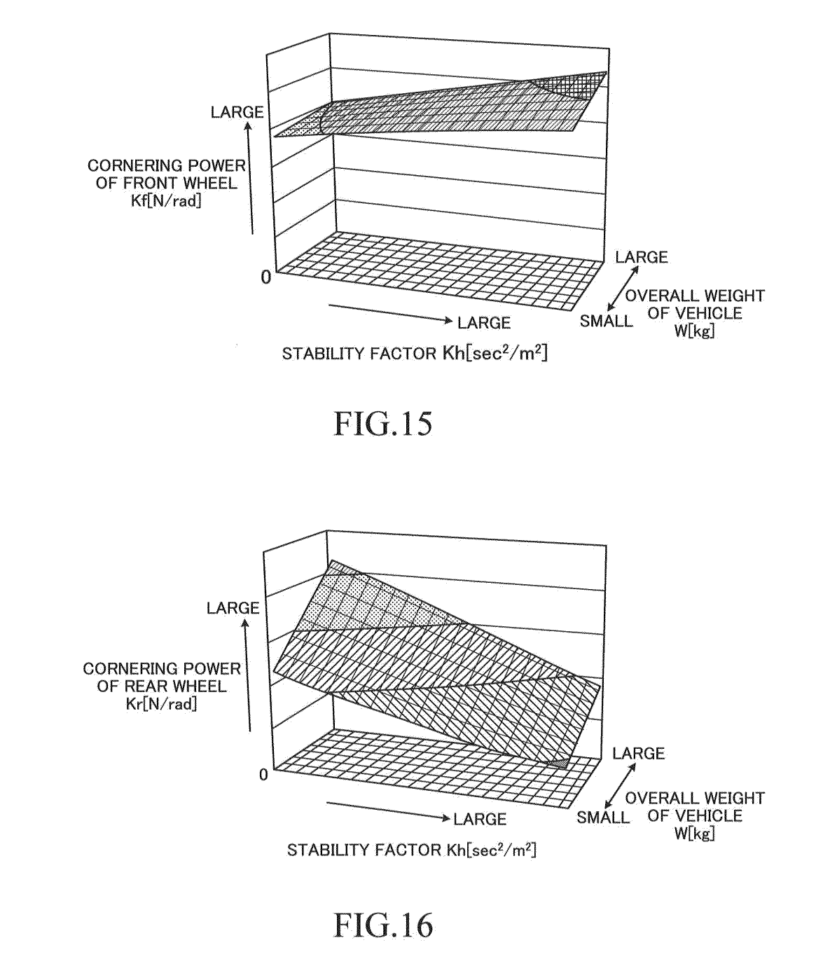

In the second embodiment, the ROM of the electronic control device 30 stores the flowchart illustrated in FIG. 8, and various values of the standard state of the vehicle described later, and stores maps illustrated in FIG. 15 to FIG. 17. Moreover, the electronic control device 30 calculates the correction amount Δγcs for the threshold in accordance with the flowchart illustrated in FIG. 8. Further, the electronic control device 30, as in the first embodiment, carries out the motion control of the vehicle in accordance with the flowchart illustrated in FIG. 5. Thus, a description of the motion control of the vehicle in this embodiment is omitted.

As illustrated in FIG. 8, Steps 210 to 240 are carried out in the same way as Steps 10 to 40 of the first embodiment, respectively. As a result, the overall weight W of the vehicle and the stability factor Kh of the vehicle are estimated, and whether or not the calculation of the correction amount Δγcs for the threshold is unnecessary is determined. Then, when an affirmative determination is made, the control proceeds to Step 340 of FIG. 4, and when a negative determination is made, the control proceeds to Step 250.

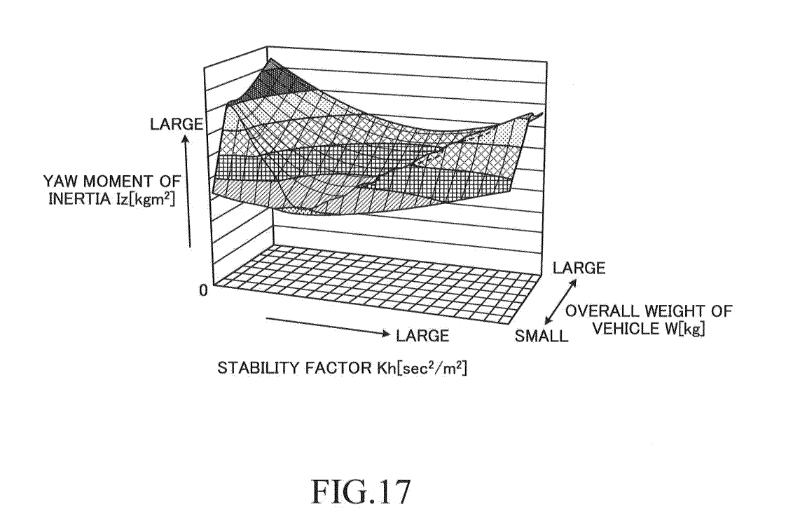

In Step 250, the cornering powers Kf and Kr of the tires of the front wheel and the rear wheel are respectively calculated using the maps illustrated in FIG. 15 and FIG. 16 based on the overall weight W of the vehicle and the stability factor Kh of the vehicle. It should be noted that gridlines drawn on planes of the maps illustrated in FIG. 15 and FIG. 16 represent scales of the overall weight W of the vehicle and the stability factor Kh. This holds true for the maps of FIG. 17 to FIG. 23 described later.

In Step 260, the yaw moment of inertia Iz [kgm²] of the vehicle is calculated using the map illustrated in FIG. 17 based on the overall weight W of the vehicle and the stability factor Kh of the vehicle.

In Step 300 carried out after Step 260, as in Step 300 of the first embodiment, the correction amount Δγcs for the threshold for the travel motion control is calculated in accordance with the flowchart illustrated in FIG. 4 as detailed later.

In this way, according to the second embodiment, in Step 250, the cornering powers Kf and Kr of the tires of the front wheel and the rear wheel are respectively calculated using the maps illustrated in FIG. 15 and FIG. 16 based on the overall weight W of the vehicle and the stability factor Kh of the vehicle. Moreover, in Step 260, the yaw moment of inertia Iz of the vehicle is calculated using the map illustrated in FIG. 17 based on the overall weight W of the vehicle and the stability factor Kh of the vehicle. Then, in Step 300, the two-wheel model of the vehicle based on the yaw moment of inertia Iz and the like is used to calculate the correction amount Δγcs for the threshold for preventing the unnecessarily early start of the control of the braking forces for stabilizing the travel motion of the vehicle.

Thus, according to the second embodiment, similarly to the case of the first embodiment, even when the overall weight of the vehicle and the vehicle longitudinal direction position of the vehicle center of gravity change, the correction amount Δγcs for the threshold can be estimated in consideration of those changes. The yaw moment of inertia Iz of the vehicle and the like can be estimated more efficiently and easily than in the case of the first embodiment, and a calculation load on the electronic control device 30 can be reduced.

It should be noted that, according to the first and second embodiments, in Step 350, whether the vehicle is in the oversteer state or the understeer state is determined. Then, when the vehicle is determined to be in the oversteer state, in Step 360, the correction amount Δγcs for the threshold when the vehicle is in the spin state is calculated. When the vehicle is determined to be in the understeer state, in Step 370, the correction amount Δγcs for the threshold when the vehicle is in the drift out state is calculated. Thus, whether the vehicle is in the spin state or the drift out state, the fear of the unnecessary determination that the turn behavior of the vehicle is degraded resulting from the changes in the overall weight of the vehicle and the vehicle longitudinal direction position of the vehicle can appropriately be reduced.

Moreover, according to the first and second embodiments, in Step 380, whether or not the absolute value |ΔKhGyNL| of the product of the deviation ΔKh of the stability factor, the lateral acceleration Gy of the vehicle, the steering gear ratio N, and the wheelbase L of the vehicle is larger than the correction amount Δγcs is determined. Then, when the affirmative determination is made, in Step 390, the correction amount Δγcs for the threshold is set to the absolute value |ΔKhGyNL| of the product. Thus, even when the stability factor Kh greatly changes as a result of the changes in the overall weight of the vehicle and the vehicle longitudinal direction position of the vehicle center of gravity, the fear of the unnecessary determination that the turn behavior of the vehicle is degraded can be effectively reduced.

Moreover, according to the first and second embodiments, in Steps 40 and 240, whether or not the calculation of the correction amount Δγcs for the threshold is unnecessary is determined based on the overall weight W of the vehicle and the stability factor Kh of the vehicle. Then, when the affirmative determination is made, the correction amount Δγcs for the threshold is not calculated, and in Steps 50 and 250, the correction amount Δγcs for the threshold is set to 0.

Therefore, in the state in which the change amounts of the overall weight W and the stability factor Kh are small with respect to the values in the standard state of the vehicle, and the amount of correction to be made for the threshold is also small, unnecessary calculation of acquiring the correction amount Δγcs for the threshold can be avoided. Thus, the calculation load on the electronic control device 30 can be reduced.

### First Modified Example

FIG. 9 is a flowchart for illustrating a principal part of the routine of calculating the correction amount Δγcs for the threshold according to a first modified example of the present invention corresponding to the first embodiment.

In this first modified example, the electronic control device 30 includes a nonvolatile storage device, which is not shown, and, each time the correction amount Δγcs for the threshold is calculated, the electronic control device 30 overwrites and stores the overall weight W of the vehicle, the stability factor Kh of the vehicle, and the correction amount Δγcs for the threshold in the storage device. This holds true for a second modified example described later.

As illustrated in FIG. 9, in the routine of calculating the correction amount Δγcs for the threshold of this modified example, when the negative determination is made in Step 40, the control does not proceed to Step 60, but proceeds to Step 45. It should be noted that Steps other than Steps 45 and 55 are executed in the same manner as in the case of the first embodiment.

In Step 45, a difference W-Wf between the overall weight W of the vehicle calculated in Step 20 and the overall weight Wf of the vehicle stored in the storage device is calculated as a change amount ΔW of the overall weight of the vehicle. Moreover, a difference Kh−Khf between the stability factor Kh of the vehicle calculated in Step 30 and the stability factor Khf of the vehicle stored in the storage device is calculated as a change amount ΔKh of the stability factor of the vehicle.

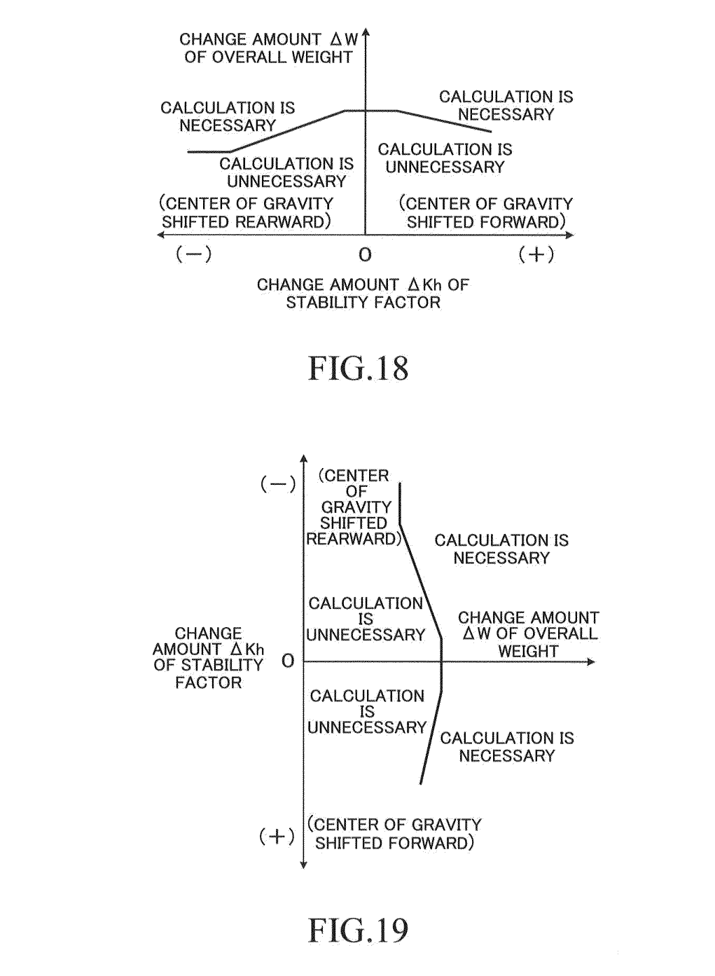

Then, whether or not the calculation of the correction amount Δγcs for the threshold is unnecessary is determined using a map illustrated in FIG. 18 based on the change amount ΔW of the overall weight W and the change amount ΔKh of the stability factor. Then, when the negative determination is made, the control proceeds to Step 60, and when the affirmative determination is made, in Step 55, the correction amount Δγcs for the threshold is set to a correction amount Δγcs for the threshold stored in the storage device, and then, the control is tentatively finished.

### Second Modified Example

FIG. 10 is a flowchart for illustrating a principal part of the routine of calculating the correction amount Δγcs for the threshold according to a second modified example of the present invention corresponding to the second embodiment.

As illustrated in FIG. 10, in the routine of calculating the correction amount Δγcs for the threshold of this modified example, when the negative determination is made in Step 240, the control does not proceed to Step 260, but proceeds to Step 245. It should be noted that Steps other than Steps 245 and 255 are executed in the same manner as in the case of the second embodiment.

In Step 245, the difference W−Wf between the overall weight W of the vehicle calculated in Step 220 and the overall weight Wf of the vehicle stored in the storage device is calculated as the change amount ΔW of the overall weight of the vehicle. Moreover, the difference Kh−Khf between the stability factor Kh of the vehicle calculated in Step 230 and the stability factor Khf of the vehicle stored in the storage device is calculated as the change amount ΔKh of the stability factor of the vehicle.

Then, whether or not the calculation of the correction amount Δγcs for the threshold is unnecessary is determined using the map illustrated in FIG. 18 based on the change amount ΔW of the overall weight W and the change amount ΔKh of the stability factor. Then, when the negative determination is made, the control proceeds to Step 260, and when the affirmative determination is made, in Step 255, the correction amount Δγcs for the threshold is set to a correction amount Δγcs for the threshold stored in the storage device, and then, the control is tentatively finished.

Moreover, according to the first and second embodiments, in Steps 45 and 245, whether or not the calculation of the correction amount Δγcs for the threshold is unnecessary is determined based on the change amount ΔW of the overall weight of the vehicle and the change amount ΔKh of the stability factor of the vehicle. Then, when the affirmative determination is made, the correction amount Δγcs for the threshold is not calculated, and in Steps 55 and 255, the correction amount Δγcs for the threshold is set to a correction amount Δγcs for the threshold stored in the storage device.

Thus, in the state in which the change amounts of the overall weight W and the stability factor Kh are small with respect to the values when the previous correction amount Δγcs is calculated, and the change in correction amount Δγcs is also small, the unnecessary calculation of acquiring the correction amount Δγcs can be avoided. Thus, the calculation load imposed on the electronic control device 30 can further be reduced compared with the first and second embodiments.

It should be noted that, in the above-mentioned Steps 45 and 245, as illustrated in FIG. 18, whether or not the change amount ΔW of the overall weight of the vehicle is equal to or less than a threshold determined by the change amount ΔKh of the stability factor of the vehicle is determined. However, as illustrated in FIG. 19, whether or not the change amount ΔKh of the stability factor of the vehicle is equal to or less than a threshold determined by the change amount ΔW of the overall weight of the vehicle may be determined.

The specific embodiment of the present invention is described in detail above. However, the present invention is not limited to the above-mentioned embodiment. It is apparent for those skilled in the art that various other embodiments may be employed within the scope of the present invention.

For example, in the respective embodiments and modified examples, in Step 420, the threshold γcs for determining the magnitude of the steering angle conversion value Δγs of the magnitude of the deviation Δγ between the actual yaw rate γ and the reference yaw rate γst of the vehicle is corrected so as to increase by the correction amount Δγcs. However, the steering angle conversion value Δγs of the magnitude of the yaw rate deviation may be corrected so as to decrease by the correction amount Δγcs, and whether or not the corrected steering angle conversion value (Δγs−Δγcs) of the magnitude of the yaw rate deviation is more than the threshold γcs may be determined.

Moreover, in the respective embodiments and modified examples, the actual yaw rate γ of the vehicle is a value estimated by using the two-wheel model of the vehicle, but may be a detected value. Moreover, whether or not the steering angle conversion value Δγs of the magnitude of the yaw rate deviation Δγ is more than the corrected threshold is determined. However, whether or not the magnitude of the deviation Δγ between the actual yaw rate γ and the reference yaw rate γst of the vehicle is more than the corrected threshold corrected so as to increase by the correction value corresponding to the correction amount Δγcs may be determined.

Moreover, in the respective embodiments and modified examples, the stabilization of the travel motion of the vehicle is achieved by controlling the braking force of the each wheel. However, the stabilization of the travel motion of the vehicle may be achieved by controlling the steering angle of the wheel or may be achieved by controlling both the braking force of the each wheel and the steering angle of the wheel.

Moreover, in the above-mentioned first and second embodiments, in Steps 40 and 240, whether or not the calculation of the reference yaw rate γst of the vehicle is unnecessary is determined based on the overall weight W of the vehicle and the stability factor Kh of the vehicle. However, this determination may be omitted.

Moreover, in the determination of whether or not the calculation of the reference yaw rate γst of the vehicle is unnecessary, the overall weight W of the vehicle may be replaced by the change amount (movable load) of the overall weight W of the vehicle with respect to the overall weight W of the vehicle in the standard state of the vehicle. Moreover, in the determination of whether or not the calculation of the reference yaw rate γst of the vehicle is unnecessary, the stability factor Kh of the vehicle may be replaced by the change amount of the position in the vehicle longitudinal direction of the vehicle center of gravity with respect to the vehicle center of gravity in the standard state of the vehicle.

Moreover, in the above-mentioned respective embodiments and modified examples, the routine of calculating the correction amount Δγcs for the threshold is independent of the routine of controlling travel motion of the vehicle. However, the routine of calculating the correction amount Δγcs for the threshold may be modified so as to be executed as a part of the routine of controlling travel motion of the vehicle.

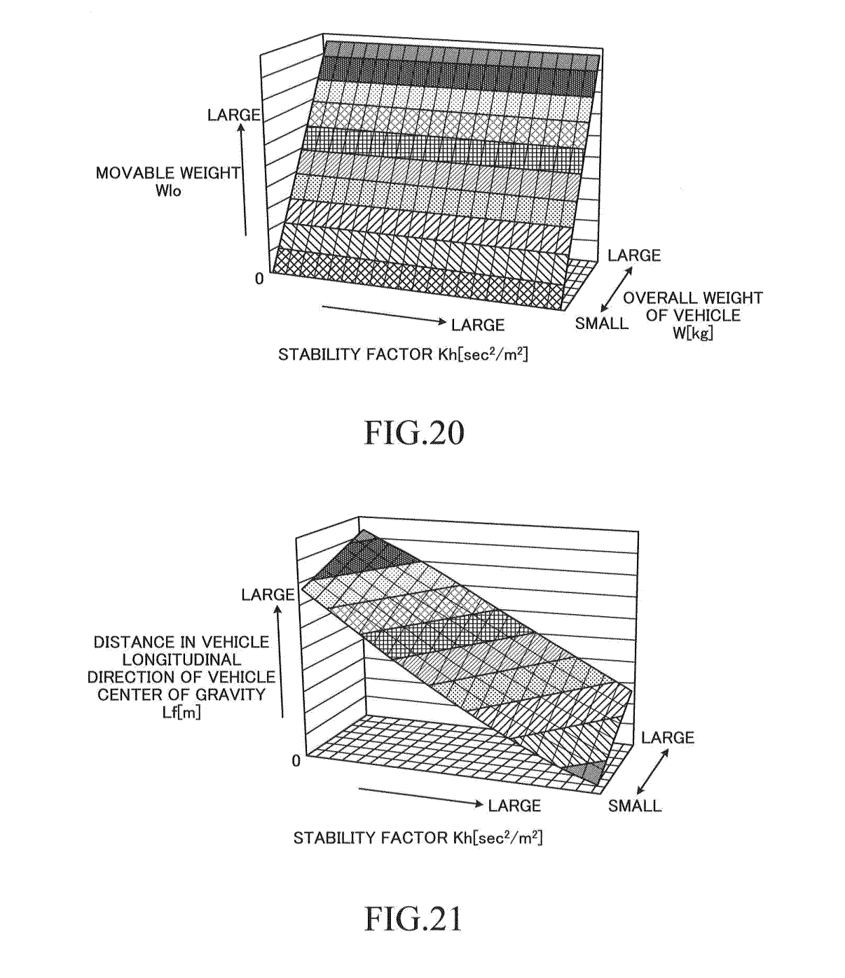

Moreover, in the above-mentioned first embodiment, the movable load Wlo of the vehicle, which is the change amount of the weight of the vehicle with respect to the standard weight Wv, is calculated in accordance with Expression (3), but may be calculated using a map illustrated in FIG. 20 based on the overall weight W of the vehicle and the stability factor Kh.

Moreover, the distance Lf in the vehicle longitudinal direction between the center of gravity of the vehicle and the axle of the front wheel may be calculated using a map illustrated in FIG. 21 based on the overall weight W of the vehicle and the stability factor Kh.

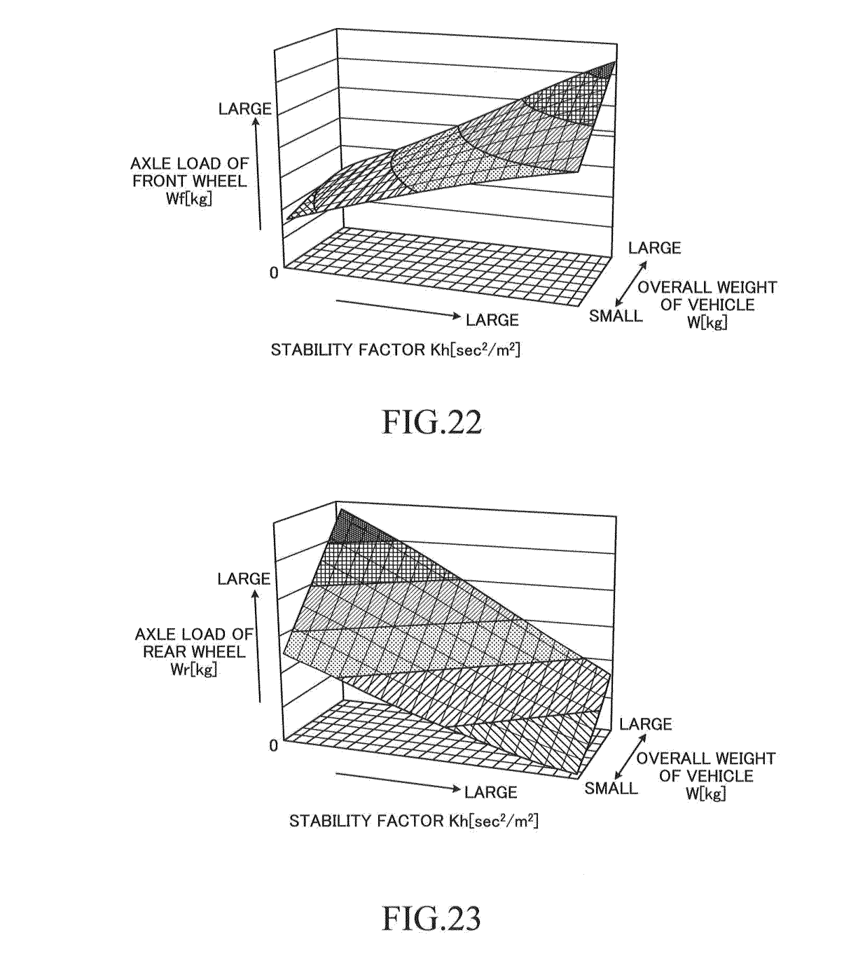

Moreover, in the above-mentioned first embodiment, the axle load Wf of the front wheels and the axle load Wr of the rear wheels are calculated based on the overall weight W of the vehicle and the distances Lr and Lf between the center of gravity of the vehicle and the axles respectively in accordance with Expressions (6) and (7). However, a modification may be made where the axle load Wf of the front wheels and the axle load Wr of the rear wheels are calculated using maps illustrated in FIG. 22 and FIG. 23 based on the overall weight W of the vehicle and the stability factor Kh of the vehicle.

Moreover, in the above-mentioned first embodiment, the cornering powers Kf and Kr of the tires of the front wheels and the rear wheels are calculated based on the axle load Wf of the front wheels and the axle load Wr of the rear wheels. However, a modification may be made where the cornering powers Kf and Kr of the tires of the front wheels and the rear wheels are calculated using the maps illustrated in FIG. 15 and FIG. 16 based on the overall weight W of the vehicle and the stability factor Kh of the vehicle.

Moreover, in the above-mentioned respective embodiments and modified examples, the vehicle is a minivan, but the vehicle to which the travel motion control device according to the present invention may be an arbitrary vehicle such as a bus or a truck having a large variation of the movable load and a large variation of the center of gravity of the vehicle.

1. A travel motion control device for a vehicle, which is configured to calculate, by using a time constant of a first-order lag set in advance, a reference motion state amount of the vehicle in a relationship of the first-order lag with respect to a normative motion state amount of the vehicle, to thereby control, when a magnitude of a deviation between an actual motion state amount of the vehicle and the reference motion state amount of the vehicle exceeds a threshold, a braking/driving force of each wheel or a steering angle of a steering wheel so as to decrease the magnitude of the deviation, wherein
the travel motion control device being configured to:
acquire a correction value corresponding to a calculation error in the reference motion state amount of the vehicle caused by a difference of the time constant of the first-order lag from an actual value resulting from at least one of a change in an overall weight of the vehicle or a change in a vehicle longitudinal direction position of a vehicle center of gravity; and
correct one of the magnitude of the deviation and the threshold by using the correction value.

2. A travel motion control device for a vehicle according to claim 1, wherein:
the correction value comprises a minimum value of a correction amount required for correcting one of the threshold and the magnitude of the deviation between the actual motion state amount of the vehicle and the reference motion state amount of the vehicle in order to prevent such a determination that the magnitude of the deviation exceeds a standard threshold set in advance for a standard state of the vehicle;
the travel motion control device comprises a storage device for storing a relationship acquired in advance between the correction value and each of the overall weight of the vehicle and a stability factor of the vehicle; and
the travel motion control device estimates the overall weight of the vehicle and the stability factor of the vehicle, and calculates the correction value by the storage device based on the estimated overall weight of the vehicle and stability factor of the vehicle.

3. A travel motion control device for a vehicle according to claim 2, wherein:
the actual motion state amount of the vehicle and the reference motion state amount of the vehicle respectively comprise an actual yaw rate of the vehicle and a reference yaw rate of the vehicle;
the actual yaw rate of the vehicle and a lateral acceleration of the vehicle are calculated based on a vehicle speed and a steering angle of a front wheel by using a two-wheel model of the vehicle in which the overall weight of the vehicle and the stability factor of the vehicle are variable parameters;
the reference yaw rate of the vehicle is calculated based on the vehicle speed, the steering angle of the front wheel, and the calculated lateral acceleration of the vehicle by using the stability factor of the vehicle and the time constant of the first-order lag set in advance for the standard state of the vehicle; and
the correction value comprises a value acquired for various overall weights and stability factors of the vehicle as the minimum value of the correction amount in order to prevent such a determination that a magnitude of a deviation between the calculated yaw rate of the vehicle and the calculated reference yaw rate of the vehicle exceeds the standard threshold.

4. A travel motion control device for a vehicle according to claim 3, wherein the correction value comprises a value for preventing, when the vehicle speed, a magnitude of the steering angle of the front wheel, a magnitude of the lateral acceleration of the vehicle, and a steering frequency are respectively less than corresponding reference values, the determination that the magnitude of the deviation between the calculated yaw rate of the vehicle and the calculated reference yaw rate of the vehicle exceeds the standard threshold.

5. A travel motion control device for a vehicle according to claim 3, wherein the two-wheel model comprises a two-wheel model in which the vehicle longitudinal direction position of the vehicle center of gravity, cornering powers of the front wheel and a rear wheel, and a yaw moment of inertia of the vehicle are variably set depending on the overall weight of the vehicle and the stability factor of the vehicle, and the time constant of the first-order lag is variably set depending on the yaw moment of inertia and the cornering powers of the front wheel and the rear wheel.

6. A travel motion control device for a vehicle according to claim 5, wherein the yaw moment of inertia of the vehicle is variably set by estimating a change amount of the overall weight of the vehicle and a change amount of the vehicle longitudinal direction position of the vehicle center of gravity with respect to the standard state of the vehicle based on the overall weight of the vehicle and the stability factor of the vehicle, estimating a change amount of the yaw moment of inertia of the vehicle based on the change amount of the overall weight of the vehicle and the change amount of the vehicle longitudinal direction position of the vehicle center of gravity, and calculating the yaw moment of inertia as a sum of the estimated change amount of the yaw moment of inertia and the yaw moment of inertia in the standard state of the vehicle.

7. A travel motion control device for a vehicle according to claim 2, wherein the standard state of the vehicle comprises a standard load state of the vehicle set in advance.

8. A travel motion control device for a vehicle according to claim 4, wherein the two-wheel model comprises a two-wheel model in which the vehicle longitudinal direction position of the vehicle center of gravity, cornering powers of the front wheel and a rear wheel, and a yaw moment of inertia of the vehicle are variably set depending on the overall weight of the vehicle and the stability factor of the vehicle, and the time constant of the first-order lag is variably set depending on the yaw moment of inertia and the cornering powers of the front wheel and the rear wheel.
